(19) United States
(12) Patent Application Publication
(10) Pub. No.: US 2019/0293541 A1
(43) Pub. Date: Sep. 26, 2019

(54) PARTICULATE MATTER DETECTION APPARATUS

(71) Applicant: DENSO CORPORATION, Kariya-city (JP)

(72) Inventors: Kazuhiko KOIKE, Nisshin-city (JP); Go MIYAGAWA, Kariya-city (JP)

(21) Appl. No.: 16/439,983

(22) Filed: Jun. 13, 2019

Related U.S. Application Data
(63) Continuation of application No. PCT/JP2017/044959, filed on Dec. 14, 2017.

(30) Foreign Application Priority Data
Dec. 15, 2016 (JP) 2016-243417
Dec. 13, 2017 (JP) 2017-238902

(51) Int. Cl. G01N 15/06; G01M 15/10; G01N 1/22; G01N 15/02; F01N 11/00

(52) U.S. Cl. CPC G01N 15/0656; G01M 15/102; F01N 3/021; G01N 15/0266; F01N 11/00; G01N 1/2252

(57) ABSTRACT

A particulate matter detection apparatus includes a sensor unit and a sensor control unit. The sensor unit outputs a single based on an amount of particulate matter. The sensor control unit detects a particle count of the particulate matter. The sensor control unit applies a first voltage to a pair of electrodes and electrostatically collects the particulate matter. After changing the applied voltage to a second voltage that differs from the first voltage in a state in which the sensor output at the first voltage has reached a threshold, the sensor control unit detects a resistance value between the pair of electrodes, and calculates the particle count using an average particle diameter of the particulate matter that is estimated from the resistance value and a mass of the particulate matter that is estimated from the sensor output.

### CROSS-REFERENCE TO RELATED APPLICATIONS

The present application is a continuation application of International Application No. PCT/JP2017/044959, filed Dec. 14, 2017, which claims priority to Japanese Patent Application No. 2016-243417, filed Dec. 15, 2016, and Japanese Patent Application No. 2017-238902, filed Dec. 13, 2017. The contents of these applications are incorporated herein by reference in their entirety.

### BACKGROUND

### Technical Field

The present disclosure relates to a particulate matter detection apparatus that detects a particle count of particulate matter that is emitted from an internal combustion engine.

### Background Art

Particulate matter (hereinafter referred to as PM, as appropriate) contained in automobile exhaust gas is a mixture that contains electrically conductive soot as a main component and soluble organic fraction (SOF) derived from unburned fuel and engine oil. For example, the particulate matter detection apparatus includes an electrical-resistance-type sensor element. The particulate matter detection apparatus applies a voltage to a detection electrode unit that is provided on a surface of an insulating substrate and forms an electrostatic field. The particulate matter detection apparatus then detects a change in a resistance value in the detection electrode unit caused by particulate matter being collected.

### SUMMARY

The present disclosure provides a particulate matter detection apparatus that includes a sensor unit and a sensor control unit. The sensor unit outputs a single based on an amount of particulate matter. The sensor control unit detects a particle count of the particulate matter. The sensor control unit applies a first voltage to a pair of electrodes and electrostatically collects the particulate matter. After changing the applied voltage to a second voltage that differs from the first voltage in a state in which the sensor output at the first voltage has reached a threshold, the sensor control unit detects a resistance value between the pair of electrodes, and calculates the particle count using an average particle diameter of the particulate matter that is estimated from the resistance value and a mass of the particulate matter that is estimated from the sensor output.

### BRIEF DESCRIPTION OF THE DRAWINGS

The present disclosure will be further clarified through the detailed description below, with reference to the accompanying drawings. The drawings are as follows:

FIG. 1 is an enlarged view of main sections of an example of a particulate matter detection sensor configuring a particulate matter detection apparatus according to a first embodiment;

FIG. 2 is an overall perspective view of a configuration example of a sensor element of the particulate matter detection sensor according to the first embodiment;

FIG. 3 is a schematic configuration diagram of an overall configuration of an exhaust emission control system for an internal combustion engine including the particulate matter detection apparatus according to the first embodiment;

FIG. 4 is a graph of an example of sensor output characteristics of the particulate matter detection sensor according to the first embodiment;

FIG. 5 is an enlarged view of main sections of another example of the particulate matter detection sensor according to the first embodiment;

FIG. 6 is an overall perspective view of another configuration example of the sensor element of the particulate matter detection sensor according to the first embodiment;

FIG. 7 is a flowchart of a particulate matter detection process performed by a sensor control unit of the particulate matter detection apparatus according to the first embodiment;

FIG. 8 is a graph of a relationship between an applied voltage to a detecting unit of the sensor element and detection time according to the first embodiment;

FIG. 9 is a graph of a relationship between the applied voltage to the detecting unit of the sensor element and inter-electrode resistance according to the first embodiment;

FIG. 10 is an overall schematic configuration diagram of a model exhaust emission control system used to examine the relationship between the applied voltage to the detecting unit of the sensor element and the inter-electrode resistance, according to the first embodiment;

FIG. 11 is a diagram of a relationship between an average particle diameter of particulate matter collected in the detecting unit of the sensor element and the inter-electrode resistance according to the first embodiment;

FIG. 12 is a graph of a relationship between the applied voltage to the detecting unit of the sensor element and an inclination of a straight line indicating the relationship between the average particle diameter of particulate matter and the inter-electrode resistance, according to the first embodiment;

FIG. 13 is a graph of a relationship between a reciprocal of the average particle diameter of collected particulate matter and the inter-electrode resistance according to the first embodiment;

FIG. 14 is a schematic diagram for explaining changes in the inter-electrode resistance depending on the magnitude of the average particle diameter of particulate matter and the magnitude of the applied voltage, according to the first embodiment;

FIG. 15 is a graph of a relationship between an estimated particle count of particulate matter and an actual measured particle count of particulate matter according to the first embodiment;

FIG. 16 is a flowchart of the particulate matter detection process performed by the sensor control unit of the particulate matter detection apparatus according to a second embodiment;

FIG. 17 is a graph of an example of a relationship between a particle count of particulate matter estimated under a condition that a detection voltage is a single voltage and the actual measured particle count of particulate matter, according to the second embodiment;

FIG. 18 is a graph of a relationship between a particle count of particulate matter estimated under a condition that the detection voltage is a plurality of voltages and the actual measured particle count of particulate matter, according to the second embodiment;

FIG. 19 is a flowchart of the particulate matter detection process performed by the sensor control unit of the particulate matter detection apparatus according to a third embodiment;

FIG. 20 is a graph of a relationship between the applied voltage to the detecting unit of the sensor element and the inter-electrode resistance according to the third embodiment;

FIG. 21 is a graph of a relationship between the applied voltage to the detecting unit of the sensor element and the inter-electrode resistance according to the third embodiment;

FIG. 22 is a graph of a relationship between the reciprocal of the average particle diameter of collected particulate matter and the inter-electrode resistance according to the third embodiment;

FIG. 23 is a graph of a relationship between the reciprocal of the average particle diameter of collected particulate matter and an inclination in a relational expression of the applied voltage and the inter-electrode resistance, according to the third embodiment;

FIG. 24 is a flowchart of the particulate matter detection process performed by the sensor control unit of the particulate matter detection apparatus according to a fourth embodiment;

FIG. 25 is a graph of changes in an element temperature during a heating process of the sensor element according to the fourth embodiment;

FIG. 26 is a graph of a relationship between whether the heating process of the sensor element is performed, and the reciprocal of the average particle diameter of the particulate matter and the inter-electrode resistance, according to the fourth embodiment;

FIG. 27 is a flowchart of the particulate matter detection process performed by the sensor control unit of the particulate matter detection apparatus according to a fifth embodiment;

FIG. 28 is an overall diagram of a configuration example of the sensor element of the particulate matter detection sensor according to a sixth embodiment;

FIG. 29 is a cross-sectional view of a configuration example of the detecting unit of the sensor element according to the sixth embodiment and is a cross-sectional view taken along line A-A in FIG. 28;

FIG. 30 is a graph of a relationship between surface resistivity and temperature of high-resistance conductive materials configuring the detecting unit of the sensor element, according to the sixth embodiment;

FIG. 31 is a diagram for explaining a measurement method for surface resistivity according to the sixth embodiment;

FIG. 32 is a diagram for explaining a method for measuring bulk resistivity according to the sixth embodiment;

FIG. 33 is a graph of a relationship between the applied voltage to the detecting unit of the sensor element and the inter-electrode resistance according to the sixth embodiment;

FIG. 34 is a graph of a relationship between the reciprocal of the average particle diameter of collected particulate matter and the inter-electrode resistance according to the sixth embodiment;

FIG. 35 is an enlarged cross-sectional view schematically showing an initial state in which particulate matter is not accumulated in the detecting unit of the sensor element according to the sixth embodiment;

FIG. 36 is an enlarged cross-sectional view schematically showing a state in which particulate matter is attached to the detecting unit of the sensor element according to the sixth embodiment;

FIG. 37 is a graph of a relationship between an accumulation amount of particulate matter in the detecting unit of the sensor element and sensor output according to the sixth embodiment;

FIG. 38 is a graph of an example of a relationship between the estimated particle count of particulate matter and the actual measured particle count of particulate matter according to the sixth embodiment;

FIG. 39 is a flowchart of the particulate matter detection process performed by the sensor control unit of the particulate matter detection apparatus according to a seventh embodiment;

FIG. 40 is a graph of a relationship between the average particle diameter and specific gravity of particulate matter according to the seventh embodiment;

FIG. 41 is a graph of an example of a relationship between the estimated particle count of particulate matter and the actual measured particle count of particulate matter according to the seventh embodiment;

FIG. 42 is a graph of an example of a relationship between the estimated particle count of particulate matter and the actual measured particle count of particulate matter according to the seventh embodiment;

FIG. 43 is a flowchart of the particulate matter detection process performed by the sensor control unit of the particulate matter detection apparatus according to an eighth embodiment;

FIG. 44 is a graph of a relationship between the average particle diameter of collected particulate matter and the inter-electrode resistance according to the eighth embodiment;

FIG. 45 is a graph of an example of a relationship between the estimated particle count of particulate matter and the actual measured particle count of particulate matter according to the eighth embodiment;

FIG. 46 is a graph of a relationship between the applied voltage to the detecting unit of the sensor element and the inter-electrode resistance according to the eighth embodiment;

FIG. 47 is a graph of a relationship between the applied voltage to the detecting unit of the sensor element and a measured current according to the eighth embodiment;

FIG. 48 is a graph of a relationship between the applied voltage to the detecting unit of the sensor element and an inter-electrode resistance change amount according to the eighth embodiment;

FIG. 49 is a graph of a relationship between the average particle diameter of collected particulate matter and the inter-electrode resistance change amount according to the eighth embodiment;

FIG. 50 is a graph of a relationship between the average particle diameter of collected particulate matter and the inter-electrode resistance change amount according to the eighth embodiment; and

FIG. 51 is a graph of a relationship between the average particle diameter of collected particulate matter and the inter-electrode resistance according to the eighth embodiment.

### DESCRIPTION OF THE EMBODIMENTS

In recent years, regulations regarding emission have become increasingly strict. Improvement in the detection accuracy of the particulate matter detection apparatus is important. In general, in the particulate matter detection apparatus, an amount of emission of particulate matter is estimated based on an output from the sensor element. Regulation of emitted particulate matter based on particle count is also being examined. For example, a sensor control apparatus is disclosed in related art. In this apparatus, a plurality of electrical-resistance-type PM detecting units are arranged and set such that the particulate matter attached to each PM detecting unit has a differing particle diameter distribution. In this apparatus, an average particle mass per single PM is set for each PM detecting unit. The PM particle count is calculated through use of PM mass that is detected from a sensor output of each PM detecting unit and the average particle mass that has been set.

In the above-described apparatus, a voltage applied to each PM detecting unit is adjusted. The average particle mass is set through advantage being taken of a particle diameter range of the particulate matter that becomes attached widening as the applied voltage increases. The PM particle count within a desired particle diameter range can thereby be calculated. Here, a state of the particulate matter that is emitted together with exhaust gas significantly changes depending on engine operation conditions. Therefore, for example, when a difference occurs between the particle diameter of the particulate matter accumulated in each PM detecting unit and a particle diameter that has been set, a problem occurs in that the detection accuracy regarding the PM particle count calculated as a result also decreases. In addition, because a plurality of PM detecting units are used, an apparatus configuration becomes complex. An issue has been found in that size increase and cost increase tend to occur.

It is thus desired to provide a particulate matter detection apparatus that improves detection accuracy regarding particulate matter by performing a calculation of particle count by reflecting changes in particle diameter of the particulate matter resulting from engine operation conditions.

An first aspect of the present disclosure is a particulate matter detection apparatus that detects particulate matter contained in a gas to be measured, the particulate matter detection apparatus including: a sensor unit that includes a detecting unit in which a pair of electrodes that are separated from each other are arranged on a surface of a substrate that is exposed to the gas to be measured, and outputs a signal based on an amount of particulate matter that is electrostatically collected in the detecting unit; and a sensor control unit that detects a particle count of the particulate matter that is electrostatically collected in the detecting unit, based on a sensor output that is transmitted from the sensor unit.

The sensor control unit includes: a collection control unit that applies a first voltage between the pair of electrodes of the detecting unit and electrostatically collects the particulate matter in the detecting unit; and a particle count calculating unit that, after changing the applied voltage between the pair of electrodes to a second voltage that differs from the first voltage in a state in which the sensor output at the first voltage has reached a threshold, detects a resistance value between the pair of electrodes, and calculates the particle count using an average particle diameter of the particulate matter that is estimated from the resistance value and a mass of the particulate matter that is estimated from the sensor output.

A second aspect of the present disclosure is a particulate matter detection apparatus that detects particulate matter contained in a gas to be measured, the particulate matter detection apparatus including: a sensor unit that includes a detecting unit in which a pair of electrodes that are separated from each other are arranged on a surface of a substrate that is exposed to the gas to be measured, and outputs a signal based on an amount of particulate matter that is electrostatically collected in the detecting unit; and a sensor control unit that detects a particle count of the particulate matter that is electrostatically collected in the detecting unit, based on a sensor output that is transmitted from the sensor unit.

The sensor control unit includes: a collection control unit that applies a first voltage between the pair of electrodes of the detecting unit and electrostatically collects the particulate matter in the detecting unit; and a particle count calculating unit that, after changing the applied voltage between the pair of electrodes to a second voltage that differs from the first voltage in a state in which the sensor output at the first voltage has reached a threshold, detects resistance values between the pair of electrodes at a plurality of voltages of which the magnitude differs, and calculates the particle count using an average particle diameter of the particulate matter that is estimated from the resistance values and a mass of the particulate matter that is estimated from the sensor output.

A third aspect of the present disclosure is a particulate matter detection apparatus that detects particulate matter contained in a gas to be measured, the particulate matter detection apparatus including: a sensor unit that includes a detecting unit in which a pair of electrodes that are separated from each other are arranged on a surface of a substrate that is exposed to the gas to be measured, and outputs a signal based on an amount of particulate matter that is electrostatically collected in the detecting unit; and a sensor control unit that detects a particle count of the particulate matter that is electrostatically collected in the detecting unit, based on a sensor output that is transmitted from the sensor unit.

The sensor control unit includes: a collection control unit that applies a first voltage between the pair of electrodes of the detecting unit and electrostatically collects the particulate matter in the detecting unit; and a particle count calculating unit that, after changing the applied voltage between the pair of electrodes to a second voltage that differs from the first voltage in a state in which the sensor output at the first voltage has reached a threshold, detects resistance values between the pair of electrodes at a plurality of voltages of which the magnitude differs, and calculates the particle count using an average particle diameter of the particulate matter that is estimated from an inclination in a relationship between the plurality of voltages and the resistance values, and a mass of the particulate matter that is estimated from the sensor output.

A fourth aspect of the present disclosure is a particulate matter detection apparatus that detects particulate matter contained in a gas to be measured, the particulate matter detection apparatus including: a sensor unit that includes a detecting unit in which a pair of electrodes that are separated from each other are arranged on a surface of a substrate that is exposed to the gas to be measured, and outputs a signal based on an amount of particulate matter that is electrostatically collected in the detecting unit; and a sensor control unit that detects a particle count of the particulate matter that is electrostatically collected in the detecting unit, based on a sensor output that is transmitted from the sensor unit.

The sensor control unit includes: a collection control unit that applies a first current between the pair of electrodes of the detecting unit and electrostatically collects the particulate matter in the detecting unit; and a particle count calculating unit that, after changing the applied current between the pair of electrodes to a second current that differs from the first current in a state in which the sensor output at the first current has reached a threshold, detects a resistance value between the pair of electrodes, and calculates the particle count using an average particle diameter of the particulate matter that is estimated from the resistance value and a mass of the particulate matter that is estimated from the sensor output.

In the above-described particulate matter detection apparatus according to the above-described first aspect, the sensor control unit operates the collection control unit and starts electrostatic collection of the particulate matter. When the sensor output reaches the threshold, the sensor control unit operates the voltage control unit, changes the applied voltage from the first voltage for collection to the second voltage, and changes a collection state.

Then, the sensor control unit detects the resistance value between the pair of electrodes. At this time, a correlation is present between the resistance value between the pair of electrodes and the average particle diameter of the particulate matter. It is clear that the detected resistance value increases as the average particle diameter increases. As a result of advantage being taken of this relationship, the average particle diameter of the particulate matter can be estimated from the detected resistance value. Furthermore, the particle count can be calculated in the particle count calculating unit through use of the mass of the particulate matter estimated from the sensor output.

As according to the above-described second aspect, after the applied voltage is changed to the second voltage that differs from the first voltage, the resistance value at each voltage can be detected at a plurality of voltages. In this case, the average particle diameter of the particulate matter can be estimated through use of the resistance values at the plurality of voltages. Alternatively, as according to the above-described third aspect, the average particle diameter of the particulate matter can be estimated using the inclination in the relationship between the plurality of voltages and the resistance values. Alternatively, as according to the above-described fourth aspect, the average particle diameter of the particulate matter can be estimated by the first current and the second current being applied between the pair of electrodes, instead of the first voltage and the second voltage.

As described above, according to the above-described first to fourth aspects, a particulate matter detection apparatus that is capable of performing calculation of the particle count by reflecting changes in the particle diameter of the particulate matter resulting from engine operation conditions and in which the detection accuracy regarding particulate matter is improved can be provided.

### First Embodiment

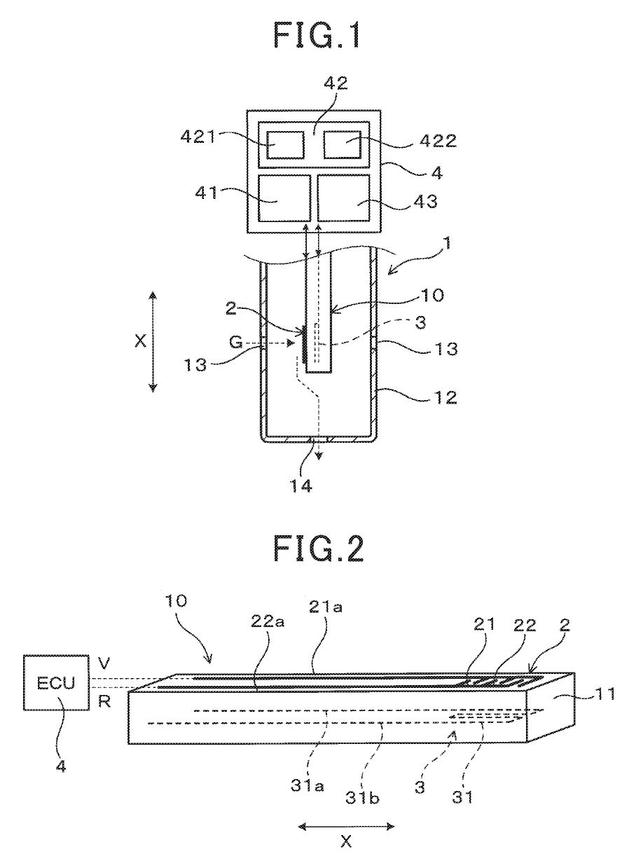

Next, an embodiment of a particulate matter detection apparatus will be described with reference to the drawings. As shown in FIG. 1 to FIG. 3, the particulate matter detection apparatus detects particulate matter contained in a gas to be measured G The particulate matter detection apparatus includes a particulate matter detection sensor 1 that serves as a sensor unit, and an electronic control unit (hereinafter referred to as an ECU) 4 that serves as a sensor control unit. The ECU 4 detects a particle count of collected particulate matter based on a sensor output from the particulate matter detection sensor 1.

The ECU 4 includes a collection control unit 41, a particle count calculating unit 42, and a heating control unit 43. The ECU 4 outputs a control signal to or receives a detection signal from the particulate matter detection sensor 1, and controls collection and detection of particulate matter. The particle count calculating unit 42 includes a voltage control unit 421 and an inter-electrode resistance detecting unit 422. Details of these units will be described hereafter.

As shown in FIG. 1, the particulate matter detection sensor 1 is configured by an electrical-resistance-type sensor element 10 and a protective cover 12 that covers an outer periphery of the sensor element 10. With an axial direction of the protective cover 12 as a longitudinal direction X (that is, an up/down direction in FIG. 1), the sensor element 10 includes, on a surface on a tip end side (that is, a lower end side in FIG. 1) thereof, a detecting unit 2 that is exposed to the gas to be measured G The detecting unit 2 is capable of being heated by a heater unit 3 that is provided inside the sensor element 10. The protective cover 12 has a cylindrical body shape that includes a metal material such as stainless steel, and has a plurality of gas-to-be-measured flow holes 13 and 14 on a side surface and a tip end surface. For example, as shown in FIG. 1, the gas to be measured is introduced into the protective cover 12 from the gas-to-be-measured flow hole 13 on the side surface opposing the detecting unit 2, and a flow of the gas to be measured G that moves along the surface of the detecting unit 2 towards the gas-to-be-measured flow hole 14 on the tip end surface is formed. As shown in FIG. 2, the sensor element 10 includes an insulating substrate 11 that is shaped into a rectangular parallelepiped and serves as a substrate, the detecting unit 2 that is formed on the surface on the tip end side (that is, a right end side in a left/right direction in FIG. 2) in the longitudinal direction X of the insulating substrate 11, and the heater unit 3 that is embedded inside the insulating substrate 11. The detecting unit 2 is configured by a pair of electrodes 21 and 22 that are formed by printing in a comb-teeth shape on one side surface (that is, an upper side surface in FIG. 2 and a left side surface in FIG. 1) of the insulating substrate 11. Each of the comb-teeth shaped electrodes 22 and 21 include a plurality of linear electrodes and configure a plurality of electrode pairs by the linear electrodes of differing polarities being alternately arranged in parallel. The electrodes 21 and 22 are respectively connected to linear lead electrodes 21a and 22a that extend from the tip end side to a base end side (that is, a left end side in FIG. 2) of the insulating substrate 11.

The heater unit 3 is configured by a heater electrode 31 that is arranged on the tip end side of the insulating substrate 11, and lead electrodes 31a and 31b that are connected to the heater electrode 31 and extend towards the base end side. For example, the insulating substrate 11 is configured by a laminated body of a plurality of insulating sheets including an insulating ceramic material, such as alumina. At this time, the heater electrode 31 and the lead electrodes 31a and 31b are formed by printing on a surface of an insulating sheet. The insulating sheet is stacked with other insulating sheets and fired as a compact that is in the shape of a predetermined rectangular parallelepiped. As a result, the sensor element 10 that includes the heater unit 3 therein can be formed.

For example, the electrodes 21 and 22 and the lead electrodes 21a and 22a of the detecting unit 2, and the heater electrode 31 and the lead electrodes 31a and 31b of the heater unit 3 include a conductive material, such as precious metal, and can be formed into a predetermined electrode shape through use of screen printing or the like. Here, the heater unit 3 may be formed by printing on a surface of the insulating substrate 11, such as a side surface that differs from a one side surface on which the detecting unit 2 is formed, rather than being embedded inside the insulating substrate 11. The heater unit 3 is merely required to be configured so as to be capable of heating the detecting unit 2. For example, the heater unit 3 can also be provided as a component that is separate from the insulating substrate 11.

A predetermined voltage is applied from the ECU 4 to each of the electrodes 21 and 22 of the detecting unit 2 via the lead electrodes 21a and 22a, respectively. That is, during operation of the collection control unit 41, a first voltage is applied between the pair of electrodes 21 and 22, and a sensor output V based on an amount of particulate matter that is electrostatically collected is acquired. In addition, during operation of the particle count calculating unit 42, a second voltage is applied from the voltage control unit 421, and the inter-electrode resistance detecting unit 422 measures a resistance value (hereinafter referred to as an inter-electrode resistance, as appropriate) R between the electrodes 21 and 22 at the second voltage.

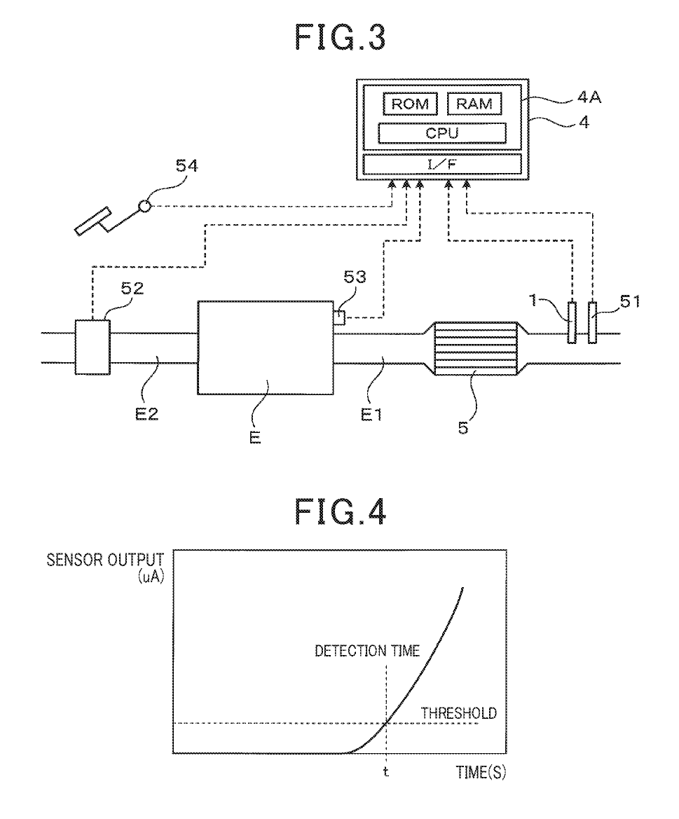

For example, the gas to be measured G is combustion exhaust gas that is emitted from an internal combustion engine E shown in FIG. 3. The particulate matter (PM) is a mixture containing soot that is a conductive component and a soluble organic fraction (SOF) that is an organic component. An amount of emission and a state of particles, such as particle diameter and chemical composition, of the particulate matter change based on an operation state of the internal combustion engine E. For example, the internal combustion engine E is a diesel engine. A diesel particulate filter (herein after referred to as a DPF) 5 that serves as a particulate matter collecting portion is arranged on an exhaust gas passage E1 through which the exhaust gas flows. The particulate matter detection sensor 1 is arranged downstream of the DPF 5, and is attached and fixed to the exhaust gas passage E1 such that a front-tip-side half portion is positioned inside the exhaust gas passage E1. The particulate matter detection sensor 1 is connected to the ECU 4 and outputs, to the ECU 4, a detection signal corresponding to a PM amount within the exhaust gas downstream of the DPF 5.

The ECU 4 controls the operations of the detecting unit 2 and the heater unit 3 of the particulate matter detection sensor 1. In addition, the ECU 4 controls the operation state of the internal combustion engine E. In FIG. 3, an exhaust gas temperature sensor 51 is attached and fixed to an exhaust gas passage E1 wall near the particulate matter detection sensor 1 and is capable of detecting an exhaust gas temperature downstream of the DPF 5. An airflow meter 52 is arranged in an intake air passage E2 of the internal combustion engine E and is configured to detect an intake airflow amount. Furthermore, a rotation speed sensor 53 that detects a rotation speed of the internal combustion engine E, an accelerator pedal sensor 54 that detects an operation of an accelerator pedal, and other various detection apparatuses are provided. Detection signals from these various detection apparatuses are inputted to the ECU 4.

The ECU 4 has a publicly known configuration that includes a microcomputer 4A. The ECU 4 is connected to the various detection apparatuses via an input and output interface I/F. The microcomputer 4A includes a central processing unit (CPU) that performs calculation processes, and a read-only memory (ROM) and a random access memory (RAM) that store therein programs, data, and the like. The microcomputer 4A periodically runs a program and controls each section of the internal combustion engine E including the particulate matter detection sensor 1. For example, the ECU 4 performs a particulate matter detection process based on a program that is stored in advance. The ECU 4 outputs a control signal to the particulate matter detection sensor 1, accumulates particulate matter in the detecting unit 2 of the sensor element 10, and detects the particulate matter that is electrostatically collected in the detecting unit 2 based on an output signal transmitted from the sensor element 10.

Here, the particle diameter of the particulate matter that is emitted into the exhaust gas passage E1 changes based on operation conditions of the internal combustion engine E. It is known that, when the particle diameter of the emitted particulate matter changes, conductivity changes, and as a result, resistance of the particulate matter collected in the detecting unit 2 also changes. Even should the chemical composition be the same and the collected amount be the same, the sensor output V differs. Here, according to the present embodiment, as a result of a change in the resistance value between the pair of electrodes 21 and 22 accompanying a change in the average particle diameter being ascertained in advance, the particle diameter of the particulate matter is estimated and the particle count is accurately calculated.

Specifically, as shown in FIG. 1, the ECU 4 includes the collection control unit 41 and the particle count calculating unit 42. The collection control unit 41 forms an electrostatic field by applying the first voltage between the pair of electrodes 21 and 22 of the detecting unit 2, and electrostatically collects the particulate matter in the gas to be measured G The particle count calculating unit 42 calculates a particle count N of the collected particulate matter. The particle count calculating unit 42 detects the resistance value R between the pair of electrodes 21 and 22 after the voltage that is applied is changed to the second voltage that differs from the first voltage, in a state in which the sensor output V at the first voltage has reached a threshold. Then, the particle count calculating unit 42 calculates the particle count N using an average particle diameter D of the particulate matter estimated from the detected resistance value R and a mass M of the particulate matter estimated from the sensor output V.

More specifically, the particle count calculating unit 42 includes the voltage control unit 421 and the inter-electrode resistance detecting unit 422. The voltage control unit 421 controls the voltage applied between the pair of electrodes 21 and 22 to a detection voltage after the applied voltage is changed to the second voltage for changing the collection state of particulate matter, when the sensor output V at the first voltage for electrostatic collection reaches the threshold. The inter-electrode resistance detecting unit 422 detects the resistance value R between the pair of electrodes 21 and 22 at the detection voltage. The detection voltage is a voltage that is the same as or differs from the second voltage and a voltage for inter-electrode resistance detection.

As shown in an example in FIG. 4, output characteristics (for example, shown as current-time characteristics herein) of the particulate matter detection sensor 1 are such that a fixed period after the start of collection is a dead period during which the sensor output is zero. Subsequently, when the pair of electrodes 21 and 22 are electrically connected by the collected particulate matter, the sensor output starts to increase. The sensor output increases based on the increase in the accumulated amount. When the output value reaches a predetermined threshold (that is, detection time tin FIG. 4) and subsequent thereto, detection of the particulate matter becomes possible.

In the voltage control unit 421, the first voltage is set such that electrostatic collection of the particulate matter by the collection control unit 41 is promoted and the sensor output V is promptly started. As a result, when the particulate matter is emitted, the threshold is quickly reached, and transition to the calculation of the particle count N by the particle count calculating unit 42 can be subsequently made.

Meanwhile, the second voltage is set such that the collection state of the particulate matter, such as contact resistance and contact state of the collected particulate matter, when the threshold is reached changes. The second voltage can be set to an arbitrary voltage that differs from the first voltage, and may be higher or lower than the first voltage. As a result of the change in the applied voltage, the collection state of the collected particulate matter changes based on the particle diameter and the detection of the resistance value R based on the particle diameter can thereby be performed by the inter-electrode resistance detecting unit 422.

In addition, the detection voltage is set to a voltage at which the change in the resistance value R based on the particle diameter can easily be identified. The detection voltage can be set to an arbitrary voltage that is suitable for detection of the resistance value R, and may be a voltage that is the same as the first voltage or the second voltage.

The second voltage preferably has a greater voltage difference from the first voltage. The change in the collection state becomes greater. The detection voltage may be set such that the voltage difference from the first voltage is greater, within a range that the resistance value R can be detected with high sensitivity.

In general, when the applied voltage is changed to a voltage on the side lower than the first voltage, the resistance value R between the pair of electrodes 21 and 22 tends to increase. In addition, this tendency increases as the particle diameter increases. Therefore, for example, a voltage that is lower than the first voltage can be set as the second voltage and the collection state of the particulate matter can be changed. Furthermore, the resistance value R can be detected with the second voltage as the detection voltage. Then, the average particle diameter D can be estimated from the resistance value R detected at the second voltage, and a relational expression of the resistance value R prepared in advance and the average particle diameter D of the particulate matter.

Therefore, as a result of the first voltage and the second voltage (for example, the detection voltage=second voltage) being appropriately set, the resistance value R can be detected with high sensitivity. Accurate estimation of the average particle diameter D from the resistance value R can be performed. In addition, the mass M of the particulate matter can be known from the sensor output V, and further, calculation of the particle count N can be accurately performed through use of the average particle diameter D estimated from the resistance value R.

In addition, the ECU 4 includes the heating control unit 43 that supplies electric power to the heater electrode 31 of the heater unit 3 and heats the detecting unit 2 to a predetermined temperature. For example, the heating control unit 43 can operate the heater unit 3 before collection and detection of the particulate matter, and remove the particulate matter that is accumulated in the detecting unit 2 by burning. As a result, the particulate matter detection sensor 1 can be regenerated.

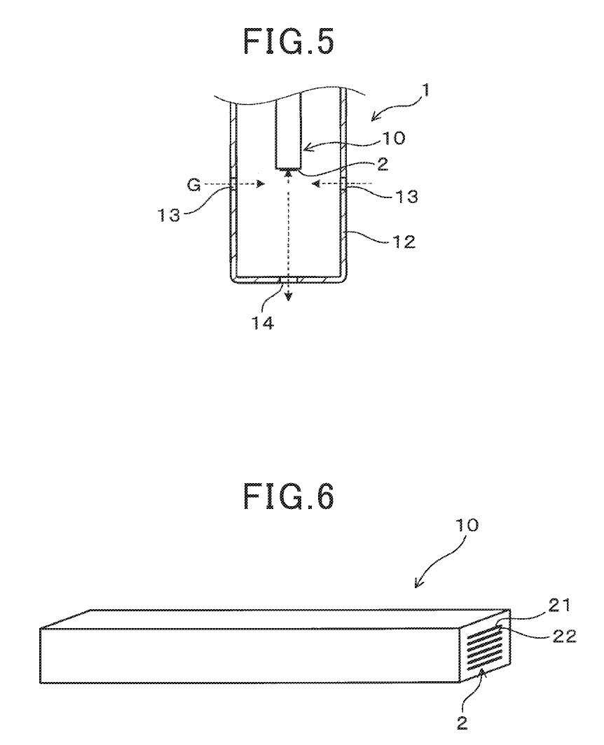

As shown in FIG. 5 and FIG. 6, the sensor element 10 may be configured to include, on the tip end surface of the insulating substrate 11, the detecting unit 2 that has a laminated structure and is configured by the pair of electrodes 21 and 22. For example, the sensor element 10 is formed by a laminated body in which electrode films to become the electrode 21 or the electrode 22 are alternately arranged between a plurality of insulating sheets to become the insulating substrate 11, being fired. At this time, end edge portions of the electrode films to become the electrode 21 or 22 are alternately exposed on the tip end surface of the insulating substrate 11, and configure the plurality of electrode pairs that include linear electrodes that have differing polarities. The electrode films to become the electrode 21 or the electrode 22 are respectively connected to lead electrodes (not shown) and are connected to each other on the base end side of the insulating substrate 11.

Inside the protective cover 12, the sensor element 10 that includes the detecting unit 2 that has the laminated structure is arranged such that the tip end surface on which the detecting unit 2 is positioned is positioned slightly towards the base end side than the plurality of gas-to-be-measured flow holes 13 that are open on the side surface of the protective cover 12. The configuration of the protective cover 12 is similar to that in the example shown in FIG. 1, described above. The gas flow is such that the gas to be measured G flows into the protective cover 12 from the plurality of gas-to-be-measured flow holes 13 on the side surface and flows towards the gas-to-be-measured flow holes 14 on the tip end surface. At this time, the flow of the gas to be measured G does not directly flow towards the detecting unit 2 from the gas-to-be-measured flow holes 13. The gas flow is such that the flow of the gas to be measured G that is introduced into the protective cover 12 merges near the tip end surface of the sensor 10 and flows towards the gas-to-be-measured flow holes 14 on the tip end surface.

In this sensor element 10 as well, the heater unit 3 (not shown) is provided. The heater electrode 31 and the lead electrodes 31a and 31b of the heater unit 3 can be formed so as to be embedded inside the insulating substrate 11, or so as to be printed on the surface of the insulating substrate 11. Here, in the sensor element 10 that has the laminated structure, the detecting unit 2 may not be formed on the tip end surface, but rather, be arranged on one side surface on the tip end side. In this case as well, the configuration in which the electrode films to become the electrodes 21 and 22 are arranged between the insulating sheets to become the insulating substrate 11, and the thickness of the insulating sheet becomes a distance between the electrodes 21 and 22 is similar.

In FIG. 3, the particulate matter detection apparatus such as this can be used for failure diagnosis of the DPF 5 that is arranged upstream of the particulate matter detection sensor 1. In general, when the DPF 5 is normal, the emitted particulate matter is collected in the DPF 5 and is hardly emitted downstream therefrom. When an abnormality of some kind occurs in the DPF 5 and collection performance regarding the particulate matter decreases, whether an abnormality has occurred can be determined in the particulate matter detection sensor 1 on the downstream side by the particle count N of the particulate matter being measured. At this time, the detection accuracy of the particulate matter detection sensor 1 can be improved and the abnormality can be promptly detected through reduction in detection variations caused by the effects of the particle diameter of the particulate matter.

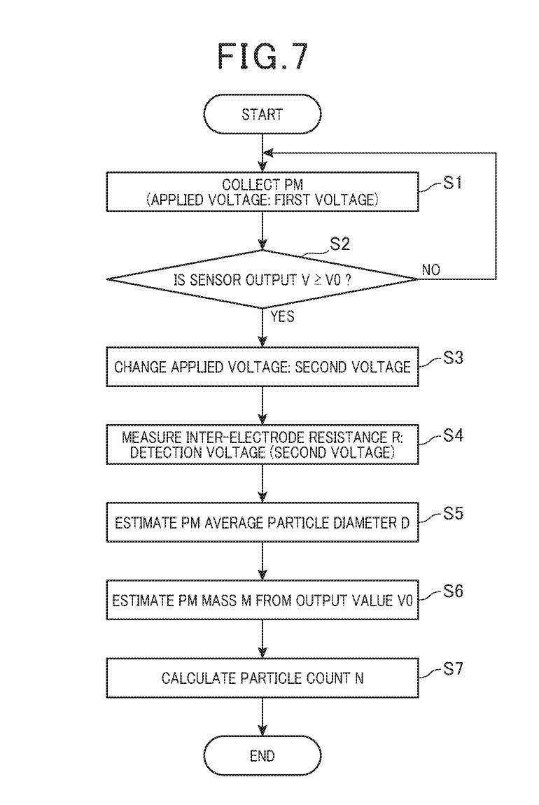

Details of the particulate matter detection process performed by the ECU 4 will be described below with reference to a flowchart. According to the present embodiment, as shown in FIG. 7, an example in which the second voltage and the detection voltage are the same voltage is given. In addition, the second voltage is a voltage that is lower than the first voltage.

In FIG. 7, when the particulate matter detection process is started, at step S1, the ECU 4 performs collection of the particulate matter to the detecting unit 2 of the particulate matter detection sensor 1. Here, at the start of collection, the particulate matter has been burned and removed in advance by a regeneration process of the particulate matter detection sensor 1 that is performed in a separate routine, and particulate matter is not accumulated in the detecting unit 2. The regeneration process is performed by the heater unit 3 provided inside the sensor element 10 being energized and the detecting unit 2 being heated. The temperature of the detecting unit 2 during regeneration is typically set to 600° C. at which soot can be burned and removed, or higher.

Step S1 is a process of the ECU 4 as the collection control unit 4. The predetermined first voltage is applied between the pair of electrodes 21 and 22 of the sensor element 10, and the particulate matter introduced into the protective cover 12 is collected in the detecting unit 2. In the detecting unit 2, the particulate matter detection sensor 1 captures the particulate matter between the pair of electrodes 21 and 22 and detects electrical characteristics that change depending on the amount of particulate matter. As described above, in the particulate matter detection sensor 1, the sensor output V preferably promptly reaches the threshold.

Therefore, the collection control unit 41 selects the first voltage to be applied between the pair of electrodes 21 and 22 such that the detection time of the sensor output V is minimum. For example, the threshold is a predetermined output that serves as a detection reference for failure diagnosis of the DPF 5 and can be set to an output voltage V0 that corresponds to a smallest accumulation amount of particulate matter that can be detected. In addition, in the laminated-type sensor element 10, for example, the distance between the pair of electrodes 21 and 22 (that is, an electrode interval) is set within a range from 5 μm to 100 μm. In general, the detection sensitivity increases as the distance decreases.

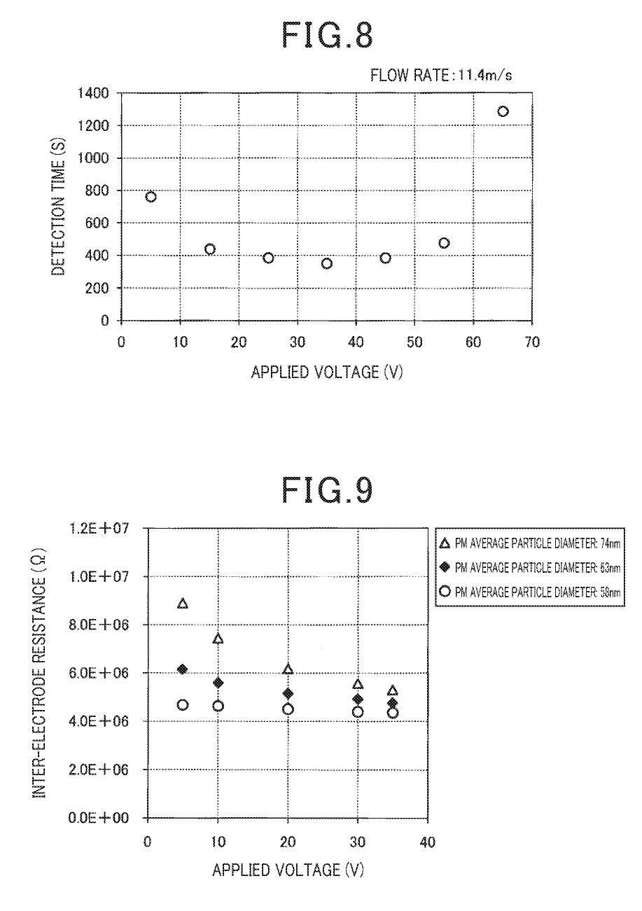

As shown in FIG. 8, when a flow rate of the exhaust gas is fixed (for example, 11.4 m/s), in a region in which the applied voltage is low, the detection time is relatively long. The detection time decreases in accompaniment with the increase in applied voltage. For example, the detection time is the shortest when the applied voltage is near 30 V to 40 V. When the applied voltage becomes higher, the detection time again increases. Therefore, as a result of the first voltage being set within a range from 30 V to 40 V (for example, 35 V) at which the detection time becomes the shortest, the sensor output V can be promptly started.

A reason for this is thought to be that electrical adhesion force P of the particulate matter to the detecting unit 2 is dependent on Coulomb force and repulsive force, as expressed in expression 1 below.

P∝D²(KEIρ1−E²/32) Expression 1:

where,

D: average particle diameter

K: coefficient

E: field intensity

I: corona current

ρ1; resistivity of particle

In expression 1, above, the first item within the parentheses expresses Coulomb force. A second item expresses repulsive force. That is, in a region in which the applied voltage is low, the Coulomb force becomes dominant and the detection time decreases. In a region in which the applied voltage is high, the repulsive force becomes dominant and the detection time increases. In this manner, the electrical adhesion force P is determined based on a balance between the Coulomb force and the repulsive force. An optimal value of the applied voltage at which the detection time becomes the shortest as a result of the Coulomb force being relatively large and the repulsive force being relatively small is assumed to exist.

Next, at step S2, the ECU 4 loads the sensor output V from the sensor element 10 and determines whether the output voltage V0 that is the threshold is reached. When determined that the sensor output V is less than the output value V0, the ECU 4 determines No at step S2 and returns to step S1. The ECU 4 continues to perform electrostatic collection and load the sensor output V.

When the sensor output V reaches the output value V0 at step S2, the ECU 4 determines that a timing to calculate the particle count of the particulate matter has arrived and proceeds to step S3. The ECU 4 calculates the particle count N of the particulate matter by a subsequent process. At this time, particulate matter is accumulated between the pair of electrodes 21 and 22, and the pair of electrodes 21 and 22 are in an electrically connected state. Steps S3 to S7 are processes of the ECU 4 as the particle count calculating unit 42. Of these steps, step S3 is a process as the voltage control unit 421 and step S4 is a process as the inter-electrode resistance detecting unit 422.

At step S3, the ECU 4 changes the voltage that is applied between the pair of electrodes 21 and 22 of the sensor element 10 from the first voltage to the second voltage that is lower than the first voltage. At this time, the state in which the accumulated particulate matter is performing electrical connection is changed. Furthermore, at step S4, the ECU 4 measures the inter-electrode resistance R between the pair of electrodes 21 and 22 at the second voltage that serves as the detection voltage. Subsequently, the ECU 4 proceeds to step S5 and estimates the average particle diameter D of the particulate matter based on the measured inter-electrode resistance R.

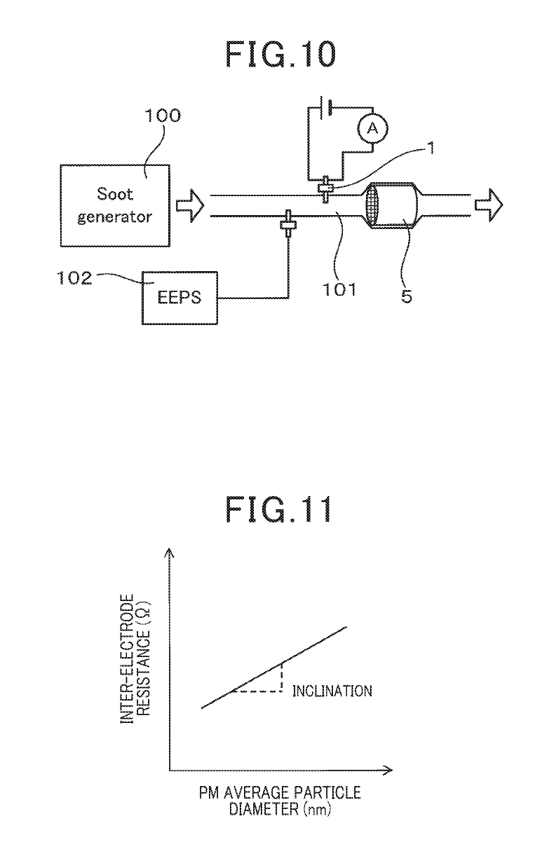

As described above, the second voltage that is applied at step S3 is merely required to be a voltage that differs from the first voltage. For example, the second voltage is a voltage that is lower than the first voltage. The difference between the first voltage and the second voltage is preferably greater and, for example, is predetermined through use of a relationship between the applied voltage and the inter-electrode resistance R shown in FIG. 9. This relationship is measured through use of a model exhaust emission control system shown in FIG. 10. A PM generation apparatus 100 that generates particulate matter mainly including soot is connected to a model exhaust gas flow path 101 in which the DPF 5 is set. The particulate matter detection sensor 1 is arranged on the upstream side of the DPF 5. A commercially available particle diameter distribution measurement apparatus (that is, an engine exhaust particle sizer [EEPS]) 102 is arranged on the upstream side of the particulate matter detection sensor 1.

PM collection by the particulate matter detection sensor 1 was performed with the average particle diameter D of the particulate matter contained in the model exhaust gas being changed, through use of the model exhaust emission control system. When the sensor output V reached the predetermined output value V0 (such as 0.12 V), PM collection was stopped and the PM generation apparatus 100 was stopped. In this state, the applied voltage to the particulate matter detection sensor 1 was changed, and the inter-electrode resistance R between the pair of electrodes 21 and 22 was measured. Measurement conditions are as follows:

Model gas temperature: 200° C.

Model gas flow rate: 15 m/s

Average particle diameter D: 74 nm, 63 nm, 58 nm

Applied voltage during PM collection: 35 V

Applied voltage during measurement: 1 V (unmeasurable), 5 V, 10 V, 20 V, 30 V, 35 V

Electrode interval: 20 μm

As shown in FIG. 9, the difference in the inter-electrode resistance R based on the average particle diameter D increases as the applied voltage during measurement (that is, the detection voltage=second voltage) decreases in relation to the applied voltage during PM collection (that is, the first voltage). For example, when the applied voltage is not changed to the second voltage, and the applied voltages during PM collection and during measurement remain the same (that is, 35 V), a sufficiently large difference is not present. In comparison, as the applied voltage during measurement becomes lower than 35 V, the inter-electrode resistance R increases, and further, the difference in the inter-electrode resistance R based on the average particle diameter D increases. In this manner, as a result of the applied voltage being changed to a lower second voltage, the average particle diameter D can be estimated from the inter-electrode resistance R.

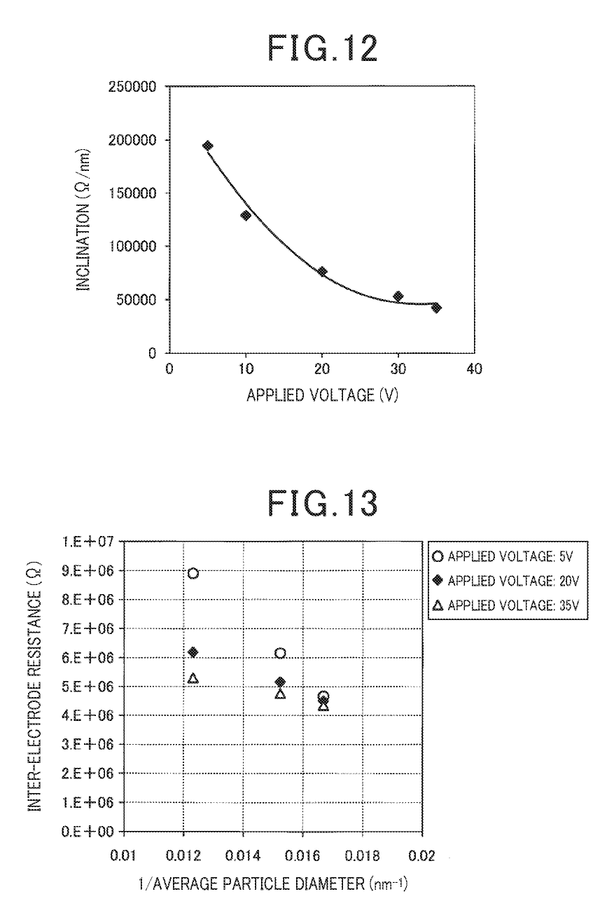

Specifically, as shown in FIG. 11, the average particle diameter D (unit: nm) of the particulate matter and the inter-electrode resistance R (unit: Ω) have a proportional relationship. As shown in FIG. 12, an inclination (unit: Ω/nm) of a straight line that expresses the relationship between the average particle diameter D of the particulate matter and the inter-electrode resistance R increases as the applied voltage decreases. In particular, in a region in which the applied voltage during measurement is about 20 V or lower, the inclination suddenly increases. Therefore, the second voltage is more preferably set to about 60% of the first voltage (for example, the second voltage is 20 V when the first voltage is 35 V) or lower. As a result, the estimation accuracy regarding the average particle diameter D based on the inter-electrode resistance R can be improved.

Here, because measurement variations increase in regions in which the applied voltage during measurement is very low (such as detection voltage=1 V), such regions are not shown in FIG. 12 and are considered unmeasurable. Therefore, when the second voltage that serves as the detection voltage is selected, for example, the second voltage is preferably set such that a voltage at which a current that flows between the pair of electrodes 21 and 22 during resistance measurement is about 1 μA is set as a lower limit value and the second voltage does not fall below the lower limit value, such that the voltage is within a range at which measurement can be performed, based on circuit configuration and the like. As a result, the measurement accuracy regarding the inter-electrode resistance R at step S4 can be improved and circuit cost can be reduced.

At step S5, the ECU 4 estimates the average particle diameter D of the particulate matter based on the measured inter-electrode resistance R using, for example, the relationship shown in FIG. 13. In FIG. 13, a horizontal axis indicates a reciprocal of the average particle diameter D (that is, a median diameter). The inter-electrode resistance R on a vertical axis increases as the average particle diameter D increases. In addition, the inter-electrode resistance R increases as the second voltage that is the applied voltage during measurement decreases.

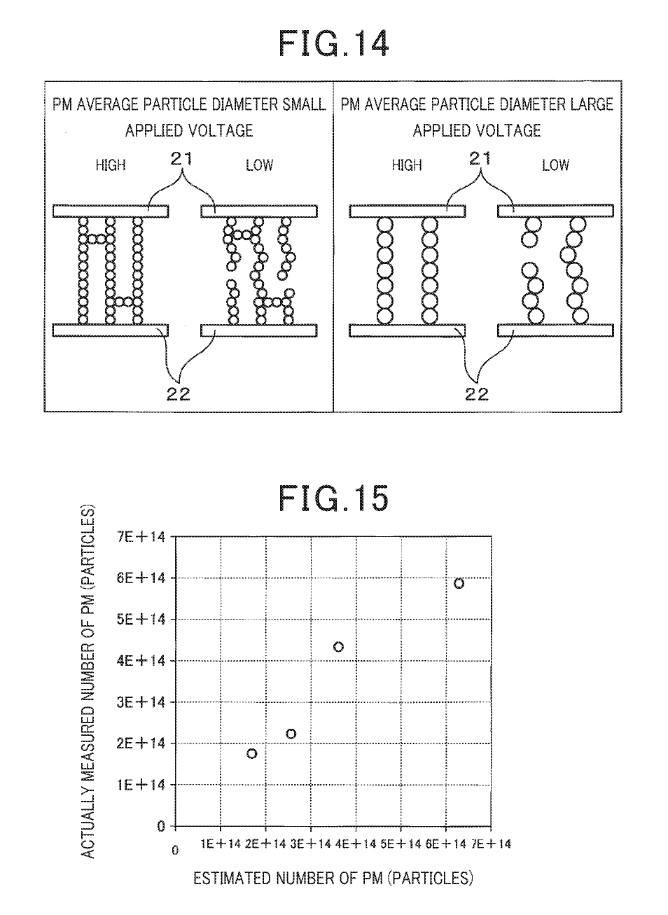

A reason for this is thought to be that, as shown in FIG. 14, the manner in which change occurs, when a change occurs in the arrangement of the collected particulate matter based on the magnitude of the applied voltage, differs between when the average particle diameter D is small and when the average particle diameter D is large. That is, in the state in which collection is performed at the first voltage, the applied voltage is relatively high, and the field intensity between the pair of electrodes 21 and 22 is in a high state. In this case, a significant difference does not occur in the state in which the particulate matter (that is, PM in FIG. 14) disposed between the electrodes are aligned and electrically connect both electrodes, based on the magnitude of the average particle diameter D. In addition, when the second voltage is a relatively high voltage, the change in the field intensity is small and the change in the collection state is also small. That is, the arrangement of the particulate matter is substantially similar to that in the state in which the sensor output V during PM collection reaches the predetermined output value V0. Therefore, a significant difference does not occur in the measured inter-electrode resistance R, as well.

In contrast, when the applied voltage is lower, the field intensity between the pair of electrodes 21 and 22 further decreases. Therefore, the force that binds the particulate matter weakens. Then, as shown in the FIG. 14, it is thought that the state of alignment of the particulate matter becomes disturbed and contact resistance between adjacent particulate matter increases. In addition, the contact state (such as a formation state of conduction paths) of the particulate matter connecting the pair of electrodes 21 and 22 also changes. The change tends to be more notable when the average particle diameter D is relatively large, compared to when the average particle diameter D is relatively small.

Here, because resistance increases as the particle diameter of the particulate matter decreases, when the predetermined sensor output V0 is reached, more particulate matter is collected as the particle diameter of the particulate matter decreases. The inter-electrode resistance R is a combined resistance of contact resistance and resistance based on the contact state of the particulate matter. Therefore, the change in the inter-electrode resistance R decreases as the particle diameter decreases and more particulate matter is collected.

In this manner, the change in the inter-electrode resistance R changes based on the particle diameter of the collected particulate matter. Therefore, as a result of the inter-electrode resistance R being measured after the applied voltage is changed to the second voltage that differs from the voltage during collection of the particulate matter and the collection state is changed, the average particle diameter D of the particulate matter can be estimated.

Here, the relationship between the average particle diameter D of the particulate matter and the inter-electrode resistance R can be examined in advance for each operating condition and measurement condition, and stored in the ROM that is a storage area of the ECU 4 as a relational expression, a map, or the like. The average particle diameter D can be estimated from the measured inter-electrode resistance R. The average particle diameter D acquired through this process is the average particle diameter of the particulate matter that is emitted downstream of the DPF 5 during the collection period from the start of electrostatic collection at step S1 to the arrival at the determination timing at step S2.

Next, the ECU 4 proceeds to step S6 and estimates the mass M of the particulate matter that is emitted during the collection period, from the sensor output V. The sensor output V has a substantially positive correlation with the mass M of the particulate matter collected in the detecting unit 2 of the sensor element 10 during the collection period. Here, the sensor output V at the time an affirmative determination is made at step S2, that is, the predetermined output value V0 is used. A reason for this is that, whether the sensor output V has reached the output value V0 is determined at step S2, and the sensor output V at the time the affirmative determination is made is essentially equal to the output value V0 that is the threshold.

Furthermore, the ECU 4 proceeds to step S7 and calculates the particle count N of the particulate matter from expression 2 and expression 3, below, using the estimated mass M and average particle diameter D of the particulate matter.

particle count N=mass M/PM average volume×PM specific gravity Expression 2:

PM average volume=4π((D/2)³/3 Expression 3:

Here, a specific gravity of the particulate matter (that is, PM specific gravity) can be set to a predetermined fixed value (such as 1 g/cm³). An average volume of the particulate matter (that is, PM average volume) is calculated from expression 3, above, based on the estimated average particle diameter D of the particulate matter, under an assumption that the particulate matter has a spherical shape.

When the particle count N of the particulate matter calculated through this series of steps is compared to a particle count that has actually been measured, as shown in FIG. 15, the estimated number of PM and the actual measured number of PM are confirmed to have a relationship in which the estimated number of PM and the actual measured number of PM substantially coincide. In this manner, the particle count N of the particulate matter can be accurately estimated by the average particle diameter D of the particulate matter being taken into consideration.

### Second Embodiment

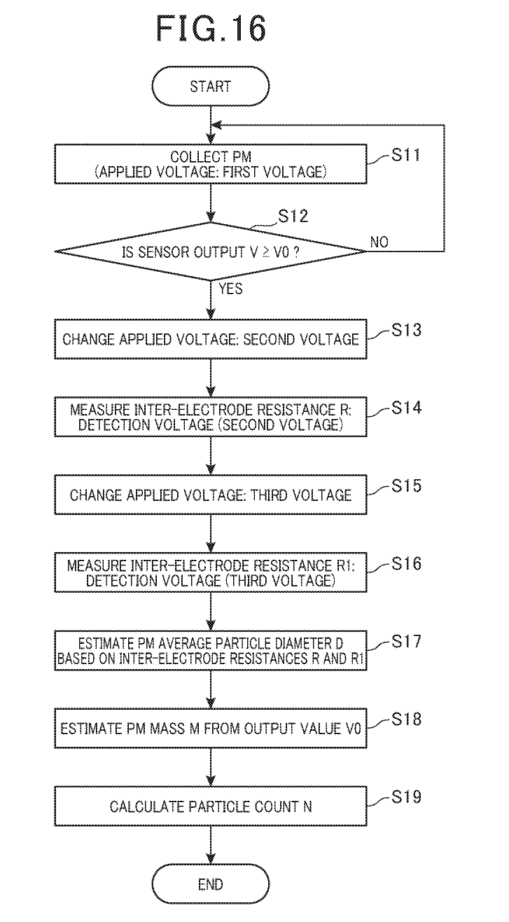

In the particulate matter detection apparatus according to a second embodiment, the basic configurations of the particulate matter detection sensor 1 serving as the sensor unit and the ECU 4 that is the sensor control unit are similar to those according to the above-described first embodiment. According to the above-described first embodiment, the average particle diameter D of the particulate matter is estimated based on the inter-electrode resistance R at the second voltage that serves as the detection voltage. However, a plurality of voltages that are lower than the first voltage may be set as the detection voltage. The inter-electrode resistance R at each of the plurality of voltages of which the magnitudes differ may be measured. The plurality of voltages may include a voltage of which the magnitude is the same as that of the second voltage. Details of the particulate matter detection process performed by the ECU 4 in this case will be described with reference to FIG. 16. Here, of the reference numbers used according to the second and subsequent embodiments, reference numbers that are the same as those used according to a previous embodiment indicate constituent elements and the like that are similar to those according to the previous embodiment, unless otherwise noted.

As shown in a flowchart in FIG. 16, according to the present embodiment, the particulate matter detection process performed by the ECU 4 that is the sensor control unit is that in which a portion of the steps according to the first embodiment shown in FIG. 7 has been changed. Specifically, steps S11 to S14 are the same process as that at steps S1 to S4 in FIG. 7. Therefore, a description thereof is simplified. Step S15 and subsequent steps that differ will mainly be described.

From steps S11 to S14, the first voltage is applied to the pair of electrodes 21 and 22 of the detecting unit 2 and electrostatic collection is performed. When the sensor output V reaches the output value V0, the applied voltage is changed to the second voltage and the collection state is changed. Subsequently, the inter-electrode resistance R at the second voltage is measured. Next, the ECU 4 proceeds to step S15 and changes the applied voltage to the pair of electrodes 21 and 22 to a third voltage that is lower than the second voltage. The ECU 4 further proceeds to step S16 and measures an inter-electrode resistance R1 at the third voltage.

Here, the second voltage and the third voltage that serve as the detection voltage are merely required to be voltages that are each lower than the first voltage, and of which the magnitudes differ from each other. Preferably, at least either or both of the second voltage and the third voltage is a voltage that is about 60% of the first voltage or lower. The estimation accuracy regarding the average particle diameter D increases as the applied voltage decreases. In addition, making the difference between the second voltage and the third voltage relatively large is more preferable.

At step S17, the ECU 4 performs the estimation of the average particle diameter D based on the resistance values at the plurality of voltages serving as the detection voltage, that is, the inter-electrode resistance R at the second voltage and the inter-electrode resistance R1 at the third voltage. For example, in a manner similar to that at step S5 in FIG. 7, described above, the average particle diameter D can be estimated for each of the inter-electrode resistances R and R1 through use of the relationship shown in FIG. 13, and an average value of the average particle diameters D can be calculated. Preferably, when the average particle diameter D is estimated, the estimation accuracy can be improved as a result of weighting being performed for each voltage. Specifically, the inter-electrode resistances R and R1 can be weighted such that the weight increases as the measurement is performed in a state in which the applied voltage is lower.

Subsequent step S18 and step S19 are similar to step S6 and step S7 in FIG. 7, described above. That is, at step S18, the ECU 4 estimates the mass M of the particulate matter using the output value V0 that serves as the sensor output V when an affirmative determination is made at step S12. Furthermore, at step S19, the ECU 4 calculates the particle count N of the particulate matter from expression 2 and expression 3, above, using the estimated mass M and average particle diameter D of the particulate matter.

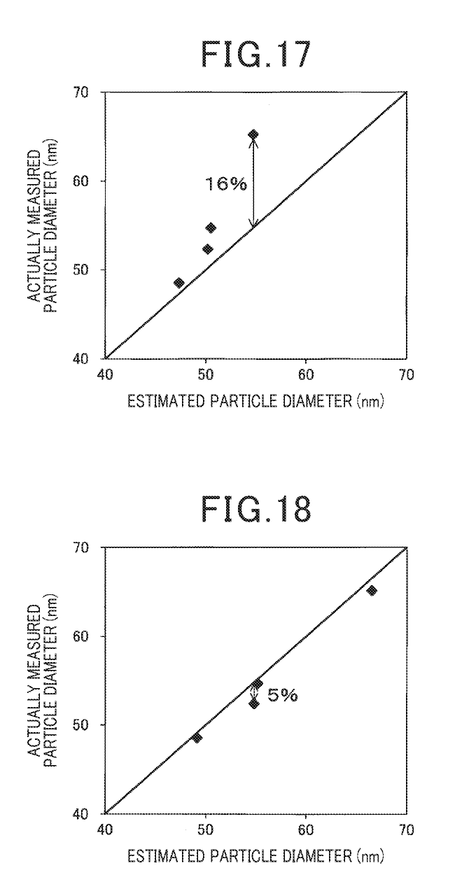

The estimation of the average particle diameter D can be more accurately performed as a result of the inter-electrode resistances R and R1 at the plurality of voltages being measured in this manner. In addition to the plurality of voltages being set to two differing voltages as according to the present embodiment, three or more differing voltages can be set and the inter-electrode resistance R can be measured for each. As shown in an example in FIG. 17, under an applied voltage condition that the applied voltage at which the inter-electrode resistance R is measured is a single voltage (that is, the particulate matter detection process according to the first embodiment), the difference that occurs between the estimated particle diameter and the actual measured particle diameter is about 16% at maximum. In contrast, as shown in FIG. 18, when the inter-electrode resistance R is measured under a plurality of applied voltage conditions, the difference that occurs between the estimated particle diameter and the actual measured particle diameter can be reduced to about 5% at maximum.

### Third Embodiment

In the particulate matter detection apparatus according to a third embodiment, the basic configurations of the particulate matter detection sensor 1 serving as the sensor unit and the ECU 4 that is the sensor control unit are similar to those according to the above-described second embodiment. According to the present embodiment as well, a plurality of voltages that are lower than the first voltage are set as the detection voltage, and the inter-electrode resistance R is measured at each of the plurality of voltages. At this time, according to the above-described second embodiment, the average particle diameter D is estimated from each of the measured inter-electrode resistances R. However, the average particle diameter D may be estimated based on an inclination I in a relationship between the plurality of voltages and the measured inter-electrode resistances R.

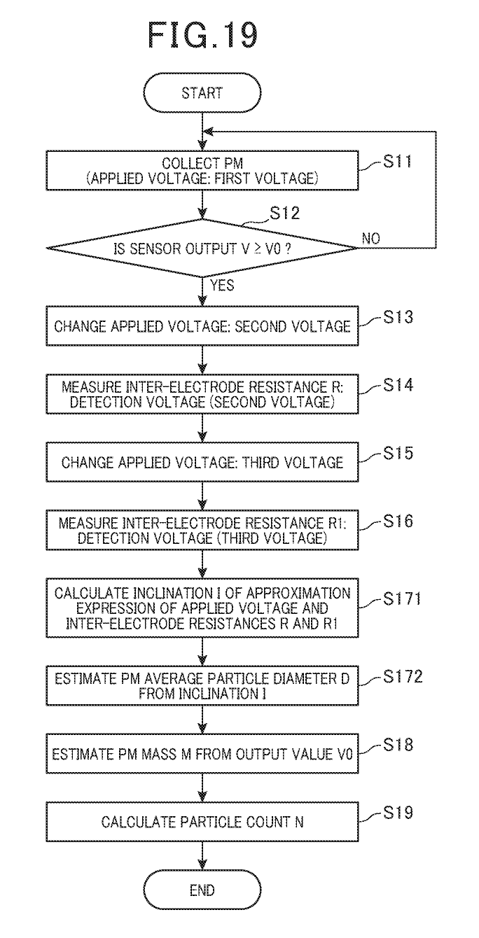

In this case, the particle count calculating unit 42 of the ECU 4 shown in FIG. 1 includes, in addition to the voltage control unit 421 and the inter-electrode resistance detecting unit 422, an inclination calculating unit (not shown) that calculates the inclination in the relationship between the plurality of voltages and the inter-electrode resistances R. Details of the particulate matter detection process performed by the ECU 4 in this case will be described with reference to FIG. 19.

As shown in the flowchart in FIG. 19, according to the present embodiment, the particulate matter detection process performed by the ECU 4 that is the sensor control unit is that in which a portion of the steps according to the second embodiment shown in FIG. 16 has been changed. Specifically, the particulate matter detection process differs only in that step S17 for estimating the average particle diameter D is performed in two stages of steps S171 and S172. Step S171 is a process as an inclination calculating unit. Steps S11 to S16 and S18 to S19 are the same process as that in FIG. 16, and therefore, are given the same reference numbers.

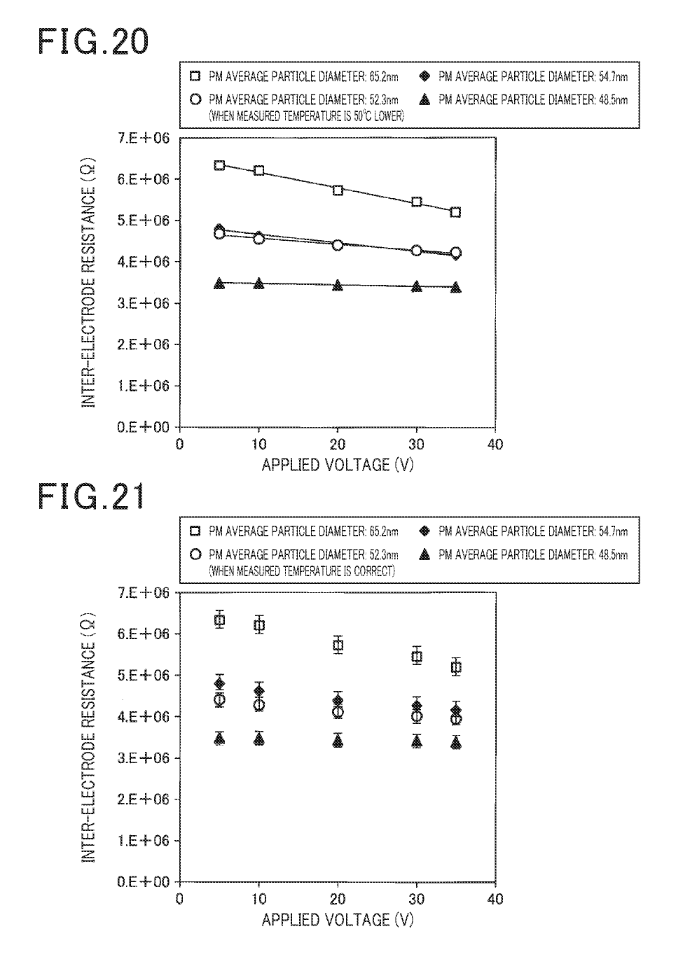

Here, as shown in a comparison in FIG. 20 and FIG. 21, the measured inter-electrode resistance R may vary as a result of the effects of a disturbance in a measured temperature or the like. In FIG. 21, the relationship between the applied voltage and the inter-electrode resistance R is found to have a favorable correlation with the magnitude of the average particle diameter D, even when the average particle diameters D of the particulate matter are within a relatively close range (such as 65.2 nm, 54.7 nm, 52.3 nm, 48.5 nm) when the measured temperatures are all at a correct preset temperature. In FIG. 21, the variation range of the inter-electrode resistances R at each applied voltage is shown. For example, even regarding 54.7 nm and 52.3 nm of which the difference in the average particle size D is small, overlap of the variation range hardly occurs. Estimation of the average particle diameter D by the steps according to the above-described second embodiment can be performed.

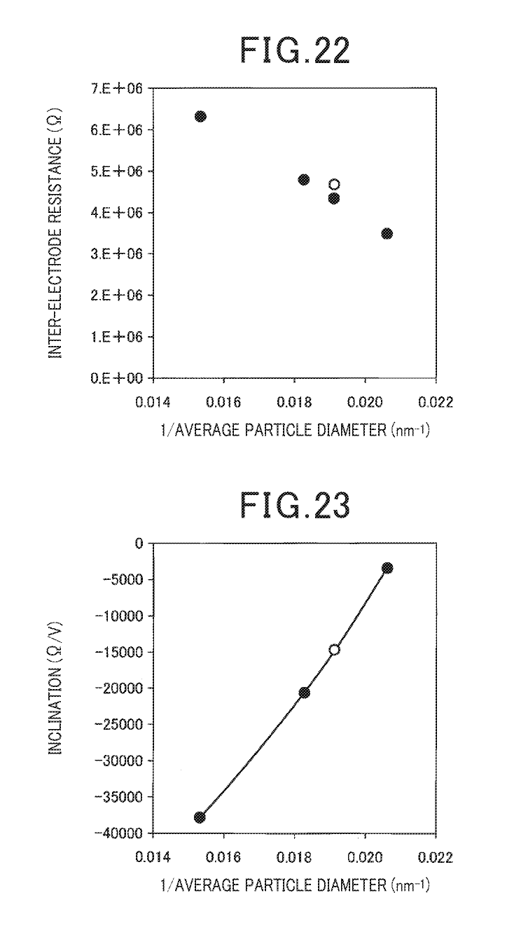

However, the relationship therebetween has a temperature dependency. For example, the inter-electrode resistance R may shift from the original value as a result of the effects of a disturbance, such as the temperature of the sensor element 10 during measurement shifting from the preset temperature. FIG. 20 shows the result of the measurement of the inter-electrode resistance R at a measurement temperature that is 50° C. lower only in the case in which the average particle diameter D is 52.3 nm. Compared to FIG. 21, the inter-electrode resistance R is close to the value of the inter-electrode resistance R when the average particle diameter D is 54.7 nm. Therefore, as shown in a case in which the applied voltage is 5 V in FIG. 22, although the reciprocal of the average particle diameter D and the inter-electrode resistance R show an overall favorable correlation, under a condition in which the temperature is low (that is, as indicated by a white circle in FIG. 22), the value of the inter-electrode resistance R becomes greater than that when a disturbance is not present, and therefore, the estimation accuracy may decrease.

In such cases as well, the inclination I of an approximation expression that linearly approximates the relationship between the applied voltage and the inter-electrode resistance R (that is, an expression of each approximation straight line shown in FIG. 20) is a fixed value. A reason for this is that the same amount of shifting occurs in the inter-electrode resistance R at each applied voltage as a result of the effects of a disturbance. As shown in a relationship with the reciprocal of the average particle diameter D in FIG. 23, the inclination I of the approximation straight line under a condition in which the temperature is low (that is, indicated by a white circle in FIG. 23) is not affected by the disturbance. Therefore, as a result of the average particle diameter D being estimated through use of the inclination I, the estimation accuracy can be improved.

In the flowchart shown in FIG. 19, based on steps S11 to S16, electrostatic collection is performed at the first voltage. After the sensor output V reaches the output value V0, the applied voltage is changed to the second voltage, and further, the inter-electrode resistances R and R1 at the second voltage and the third voltage are measured. Next, the ECU 4 proceeds to step S171 and calculates the inclination I of the approximation expression that linearly approximates the relationship between the applied voltage and the inter-electrode resistance R, from the second voltage, the third voltage, and the inter-electrode resistances R and R1. Then, at step S172, the ECU 4 can accurately estimate the average particle diameter D of the particulate matter based on the relationship in FIG. 23, from the inclination I of the approximation expression.

Subsequently, the ECU 4 can proceed to steps S18 and S19, and estimate the mass M of the particulate matter based on the output value V0 and calculate the particle count N of the particulate matter using the mass M and the average particle diameter D.

### Fourth Embodiment

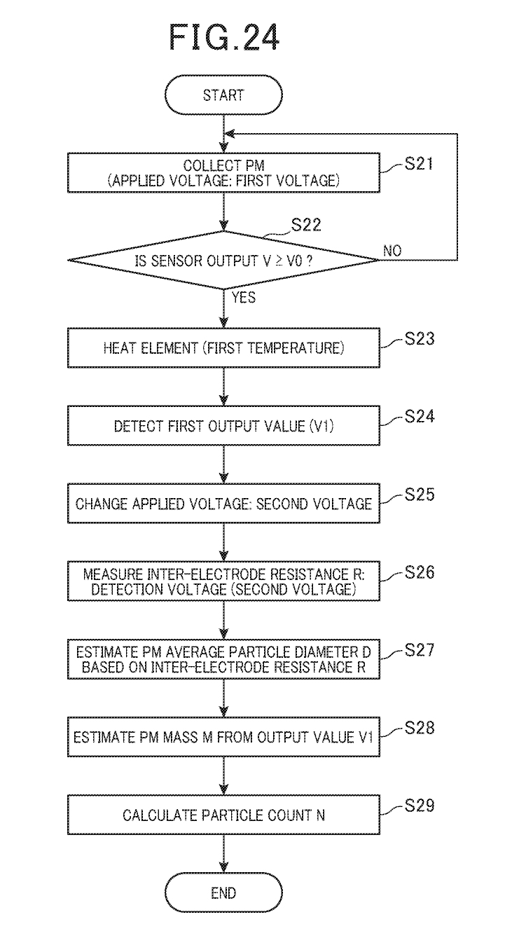

In the particulate matter detection apparatus according to a fourth embodiment, the basic configurations of the particulate matter detection sensor 1 serving as the sensor unit and the ECU 4 that is the sensor control unit are similar to those according to the above-described first embodiment. According to the above-described first and second embodiments, the heater unit 3 of the particulate matter detection sensor 1 is used for regeneration of the detecting unit 2 before collection of the particulate matter. However, the heater unit 3 can be used to perform a heating process on the particulate matter that is accumulated in the detecting unit 2 when the particle count N is detected. At this time, the heating control unit 43 of the ECU 4 energizes the heater unit 3, and heats and holds the detecting unit 2 at a temperature that is lower than that during regeneration, such as at a temperature at which the SOF within the accumulated particulate matter can be volatilized and the soot does not burn. Details of the particulate matter detection process performed by the ECU 4 in this case will be described with reference to FIG. 24.

As shown in a flowchart in FIG. 24, according to the present embodiment, the particulate matter detection process performed by the ECU 4 that is the sensor control unit is that in which a portion of the steps according to the first embodiment shown in FIG. 7 has been changed. Specifically, steps S21 to S22 are the same process as that at steps S1 to S2 in FIG. 7. Therefore, a description thereof is omitted. At step S23, the ECU 4 supplies electric power to the heater unit 3 of the sensor element 10 and heats the detecting unit 2. The temperature is increased to a first temperature at which only the SOF is removed by volatilization and the soot is not removed.

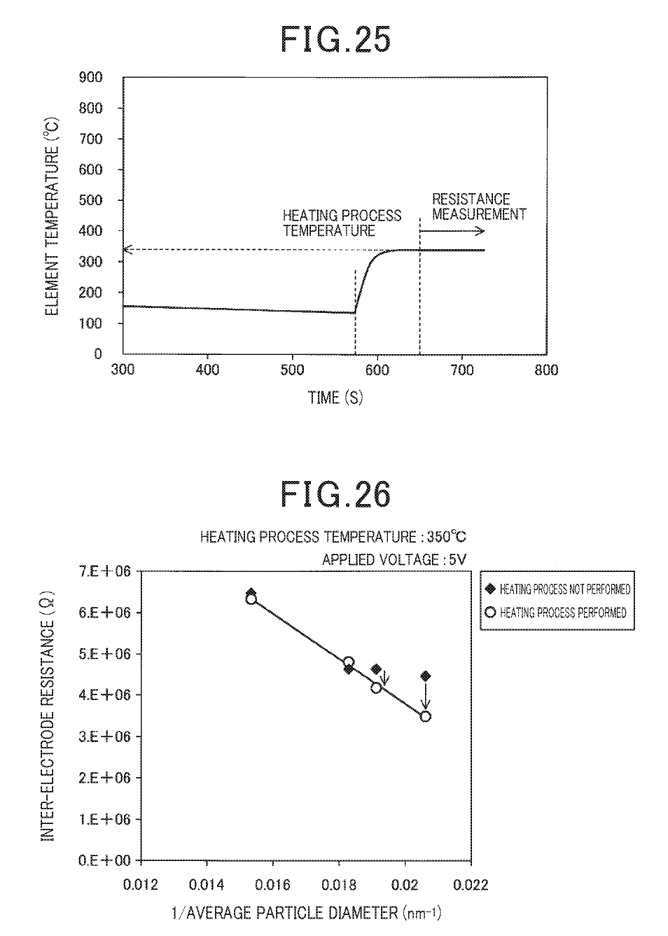

As shown in an example of a heating process pattern in FIG. 25, the first temperature that is a heating process temperature is selected within a range between 200° C. or higher and 400° C. or lower (such as 350° C.). At this time, the heating control unit 43 starts heating when the output value V0 is reached or subsequent thereto, and controls a temperature increase speed such that the temperature converges at the predetermined first temperature. For example, the temperature increase speed can be fixed until the temperature is near the first temperature. Subsequently, the temperature increase speed can be gradually reduced, and the temperature can be converged at the first temperature.

At this time, in accompaniment with the temperature of the detecting unit 2 increasing and converging at the first temperature by the operation of the heater unit 3, the sensor output V converges at a first output value V1 at the first temperature so as to form a similar curve. At this time, as a result of the detecting unit 2 being heated, and the SOF being volatilized and only the soot remaining, conductivity improves. Therefore, in general, the first output value V1 is greater than the output value V0. This also includes the effect of temperature characteristics in which the resistance of soot decreases as a result of temperature increase.

Therefore, at step S24, the ECU 4 loads the first output value V1 at the first temperature after the first temperature is reached. An amount of time required for the first temperature to be reached is an amount of time required for the temperature to reach the first temperature, and heating and holding of the temperature to be performed until the SOF is sufficiently volatilized. The amount of time can be arbitrarily set by experiments and the like being performed in advance.

Subsequent steps S25 to step S27 are the same process as that at steps S3 to S5 in FIG. 7, described above. At step S25, the ECU 4 changes the applied voltage to the pair of electrodes 21 and 22 from the first voltage to the second voltage and further proceeds to step S26. The ECU 4 then measures the inter-electrode resistance R at the second voltage that serves as the detection voltage. Subsequently, the ECU 4 proceeds to step S27 and estimates the average particle diameter D of the particulate matter based on the measured inter-electrode resistance R.

As described above, the effect of the SOF in the discharged particulate matter is not necessarily significant during detection of particulate matter. However, for example, because the SOF is not easily volatilized under a condition in which the exhaust temperature is low, the proportion of SOF within the particulate matter tends to be high. As shown in a relationship between the inter-electrode resistance R measured before and after the heating process and the average particle diameter D in FIG. 26, the difference in the resistance value as a result of whether the heating process is performed is significant. It is clear that detection error is reduced as a result of the high-resistance SOF being volatilized by the heating process being performed.

Next, the ECU 4 proceeds to step S28 and estimates the mass M of the particulate matter collected in the detecting unit 2 of the sensor element 10 during the collection period based on the first output value V1. The first output value V1 is the sensor output V based on the particulate matter mainly including soot. The first output value V1 has a positive correlation with the mass M of the particulate matter. As a result of this relationship being examined in advance and stored in the ROM that is a storage area of the ECU 4, the mass M can be estimated.

Subsequently, the ECU 4 proceeds to step S29 and calculates the particle count N of the particulate matter from the estimated mass M and average particle diameter D of the particulate matter, by a process similar to that at step S7 in FIG. 7, described above. As a result of the heating process of the detecting unit 2 being performed after collection in this manner, the effects of SOF and exhaust temperature can be eliminated.

### Fifth Embodiment

In the particulate matter detection apparatus according to a fifth embodiment, the basic configurations of the particulate matter detection sensor 1 serving as the sensor unit and the ECU 4 that is the sensor control unit are similar to those according to the above-described first embodiment. In addition, the process of eliminating the effects of SOF by the heating process on the detecting unit 2 being performed after collection by the heating control unit 43 of the ECU 4 is similar to that according to the above-described fourth embodiment. Only the process of estimating the mass M of the particulate matter differs.

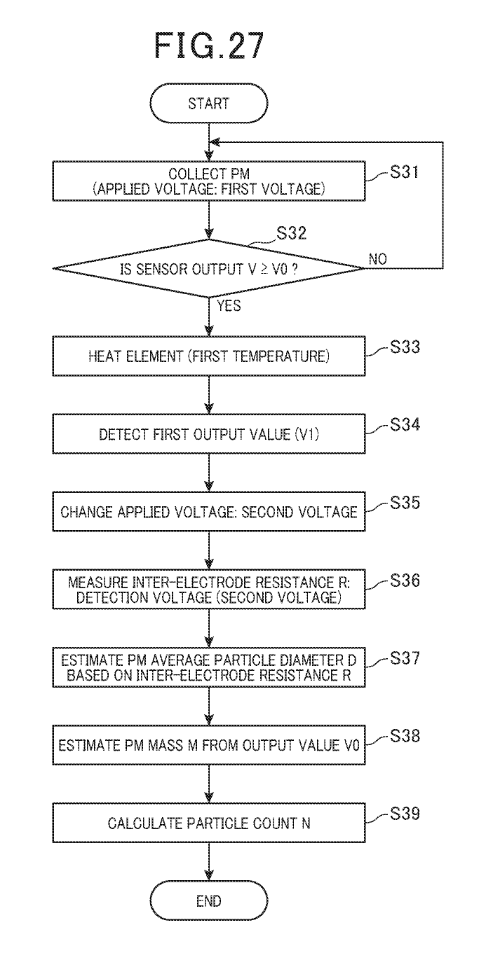

Specifically, in a flowchart shown in FIG. 27, of the particulate matter detection process performed by the ECU 4, step S31 to S37 are the same process as that at steps S21 to S27 according to the fourth embodiment shown in FIG. 24. The average particle diameter D of the particulate matter is accurately estimated by the applied voltage being changed to the second voltage after the heating process and the inter-electrode resistance R being measured.

Subsequently, the ECU 4 proceeds to step S38 and estimates the mass M of the particulate matter collected in the detecting unit 2 of the sensor element 10 during the collection period, based on the output value V0 that is the sensor output V at step S32. Because the proportion of SOF occupying the mass M of the particulate matter is relatively small, the mass M of the particulate matter can also be estimated based on the output value V0, in a manner similar to that according to the above-described first embodiment. Subsequently, at step S39, the ECU 4 can calculate the particle count N of the particulate matter using the estimated mass M and average particle diameter D of the particulate matter.

### Sixth Embodiment

In the particulate matter detection process according to the embodiments above, a case in which the particulate matter detection sensor 1 is the laminated-type sensor element 10 that includes the detecting unit 2 that has the laminated structure is mainly described. However, as shown in FIG. 2, the particulate matter detection sensor 1 can also be a printed-type sensor element 10 in which the pair of electrodes 21 and 22 are formed by printing on the surface of the insulating substrate 11 that is shaped into a rectangular parallelepiped. In this case, the distance between the pair of electrodes 21 and 22, that is, the electrode interval is wider than that in the laminated-type sensor element 10, and for example, can be selected as appropriate within a range from 50 μm to 500 μm.

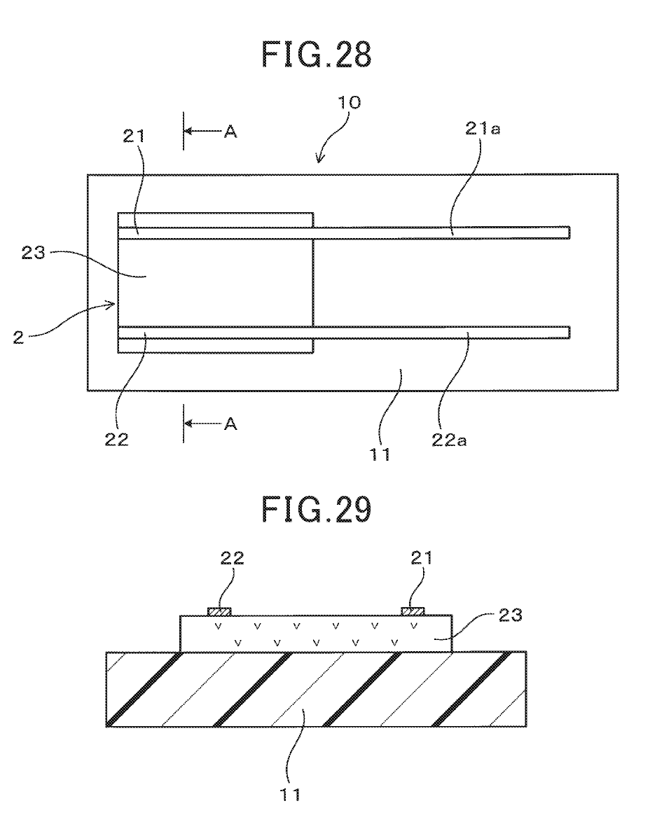

In addition, in the case in which the particulate matter detection sensor 1 is the printed-type sensor element 10, as shown in FIG. 28 and FIG. 29, a detection conductive portion 23 may be arranged on the surface of the insulating substrate 11 that serves as the substrate. The detection conductive portion 23 includes a conductive material that has a higher resistivity than the particulate matter and a high-resistance conductive material described hereafter.

The particulate matter detection process performed by the ECU 4 is effective not only for the configuration in which an area between the pair of electrodes 21 and 22 of the sensor element 10 includes an insulating material as according to the above-described embodiments, but also for a configuration in which the area between the pair of electrodes 21 and 22 of the sensor element 10 includes the high-resistance conductive material. This will be described below.

The detection conductive portion 23 is arranged on a surface on the tip end side (that is, one end side in FIG. 28) in the longitudinal direction X to become the detecting unit 2. The pair of electrodes 21 and 22 are each arranged so as to extend in the longitudinal direction X, with a space therebetween on the surface of the detection conductive portion 23 (that is, a surface on the side opposite the substrate 11). The pair of electrodes 21 and 22 are respectively connected to the linear lead electrodes 21a and 22a that extend from the tip end side to the base end side (that is, the other end side in FIG. 28) of the insulating substrate 11. Here, the pair of electrodes 21 and 22 may be configured such that a plurality of sets of electrode pairs are, for example, arranged in a comb-teeth shape, in a manner similar to that in the sensor element 10 shown in FIG. 2.

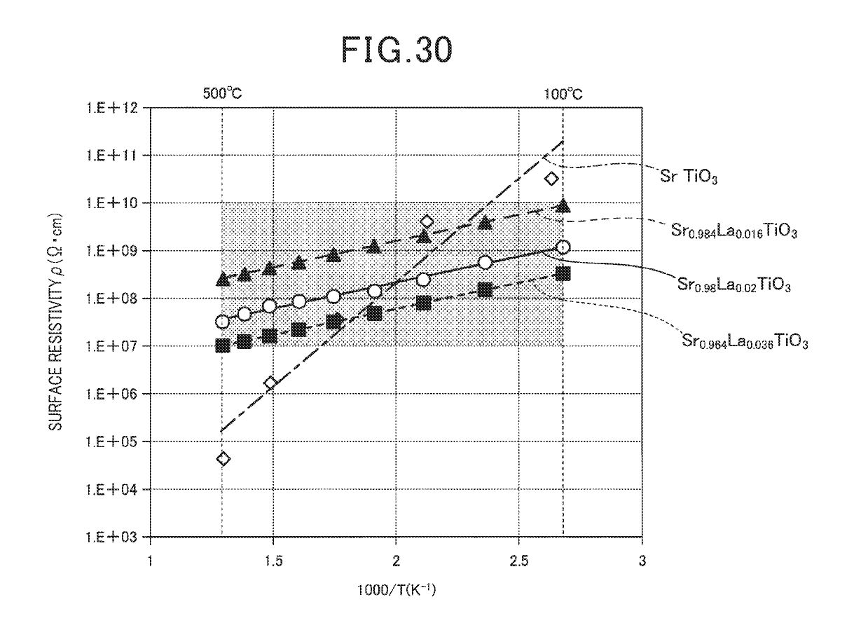

Here, as shown in FIG. 30, a high-resistance conductive material 20 that is used in the detection conductive portion 23 is preferably a conductive material of which surface resistivity is within a range from 1.0×10⁷ to 1.0×10¹⁰ Ω·cm at a temperature range from 100 to 500° C. For example, as a conductive material of which the surface resistivity meets the above-described numeric range, a ceramic that has a perovskite structure of which a molecular formula is expressed by ABO₃ can be used. In the above-described molecular formula, an A site is at least one type selected from La, Sr, Ca, and Mg, and a B site is at least one type selected from Ti, Al, Zr, and Y. Regarding the A site, a main component is preferably Sr and a sub-component is preferably La. Regarding the B site, a perovskite-type ceramic that is Ti (that is, Sr_{1-X}La_{X}TiO₃) is preferably used.

As shown in a relationship between the surface resistivity p of the perovskite-type ceramic and the temperature in FIG. 30, when x in (Sr_{1-X}La_{X}TiO₃) is set within a range from 0.016 to 0.036, the surface resistivity p becomes 1.0×10⁷ to 1.0×10¹⁰ Ω·cm at the temperature range from 100 to 500° C. Therefore, such ceramics (such as Sr_{0.984}La_{0.016}TiO₃, S_{r0.98}La_{0.02}TiO₃, and Sr_{0.964}La_{0.036}TiO₃) can be favorably used as the material composing the detection conductive portion 23.

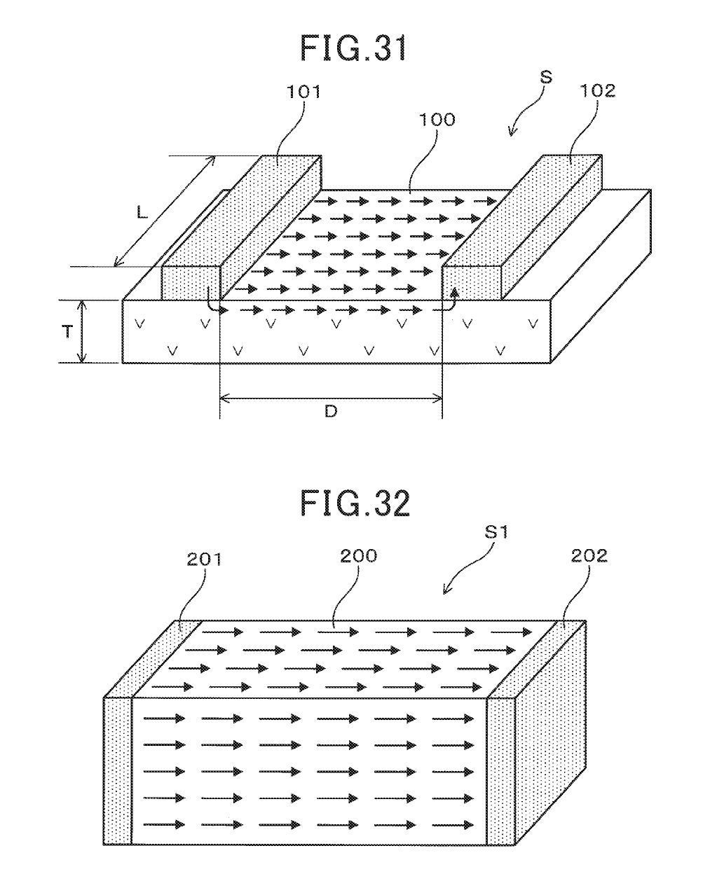

Here, the “surface resistivity ρ” refers to a value that is calculated through use of expression 4, below, by a sample S shown in FIG. 31 being fabricated and the electrical resistance between measurement electrodes 101 and 102 (that is, an inter-electrode resistance) being measured.

According to the present embodiment, the surface resistivity p of the conductive material is measured in the following manner. That is, first, the sample S shown in FIG. 31 is fabricated. The sample S includes a plate-shaped substrate 100 that includes the conductive material and has a thickness T of 1.4 mm, and the pair of measurement electrodes 101 and 102 that are formed on a main surface of the plate-shaped substrate 100 and of which a length is L and an interval is D. The sample S such as this is formed, and the electrical resistance R (unit: Ω) between the pair of measurement electrodes 101 and 102 is measured. The surface resistivity ρ is calculated by expression 4, below.

ρ=R×L×T/D Expression 4:

Here, in the present specification, when “resistivity” is simply described, “resistivity” refers to so-called bulk resistivity. As shown in FIG. 23, for example, this can be calculated by a bulk sample S1 that includes a substrate portion 200 including the conductive material and a pair of measurement electrodes 201 and 202 formed on a side surface of the substrate portion 200 being fabricated, and the electrical resistance between the pair of electrodes 201 and 202 being measured.

As shown in FIG. 30, when La is not added (SrTiO₃), the surface resistivity ρ is about 1.0×10⁵ to 1.0×10¹¹ Ω·cm at the temperature range of 100 to 500° C., and falls outside the range of 1.0×10⁷ to 1.0×10¹⁰ Ω·cm on the low temperature side and the high temperature side. Based on this result, it is clear that changes in the surface resistivity ρ based on temperature are reduced when the ceramic contains La.

Here, to acquire the graph in FIG. 30, the measurement of the surface resistivity ρ was, more specifically, performed as described below. That is, ceramics in which x in Sr_{1-X}La_{X}TiO₃ is 0, 0.016, 0.02, and 0.36 were fabricated. The samples S (for example, see FIG. 31) were fabricated using these ceramics. Each sample S includes the plate-shaped substrate 100 of which the thickness T is 1.4 mm, and the pair of measurement electrodes 101 and 102 formed on the main surface of the plate-shaped substrate 100 and of which the length L is 16 mm and the interval D is 800 μm. The sample S was then heated in the atmosphere to 100 to 500° C. A voltage of 5 to 1000 V was applied between the measurement electrodes 101 and 102, and the electrical resistance R was measured. Then, the surface resistivity ρ was calculated using expression 4, above.

According to the present embodiment, any of the above-described first to fifth embodiments can be applied for the particulate matter detection process performed by the ECU 4 that is the sensor control unit. That is, the first voltage can be applied during collection of the particulate matter and the threshold can be promptly reached. Then, for example, after the applied voltage is changed to the second voltage that is lower than the first voltage, the average particle diameter D can be accurately detected from the resistance value that is detected at the second voltage or a plurality of voltages. Furthermore, the particle count N during the collection period can be calculated from the mass M of the particulate matter that is estimated using the output value V0 or the first output value V1 after the heating process, and the PM specific gravity that is a known constant.

Specifically, a process that is the same as that at steps S1 to S7 according to the first embodiment shown in FIG. 7 can be performed.

That is, at steps S1 to S3, the first voltage is applied to the pair of electrodes 21 and 22 of the detecting unit 2, and electrostatic collection is performed. When the sensor output V reaches the output value V0, the applied voltage is changed to the second voltage and the collection state is changed. Subsequently, at step S4, the inter-electrode resistance R at the second voltage that serves as the detection voltage is measured. At step S5, the average particle diameter D of the particulate matter is estimated from the inter-electrode resistance R. Then, at steps S6 and S7, the mass M of the particulate matter is estimated based on the output value V0, and the particle count N of the particulate matter is calculated using the specific gravity of the particulate matter and the estimated mass M of the particulate matter.

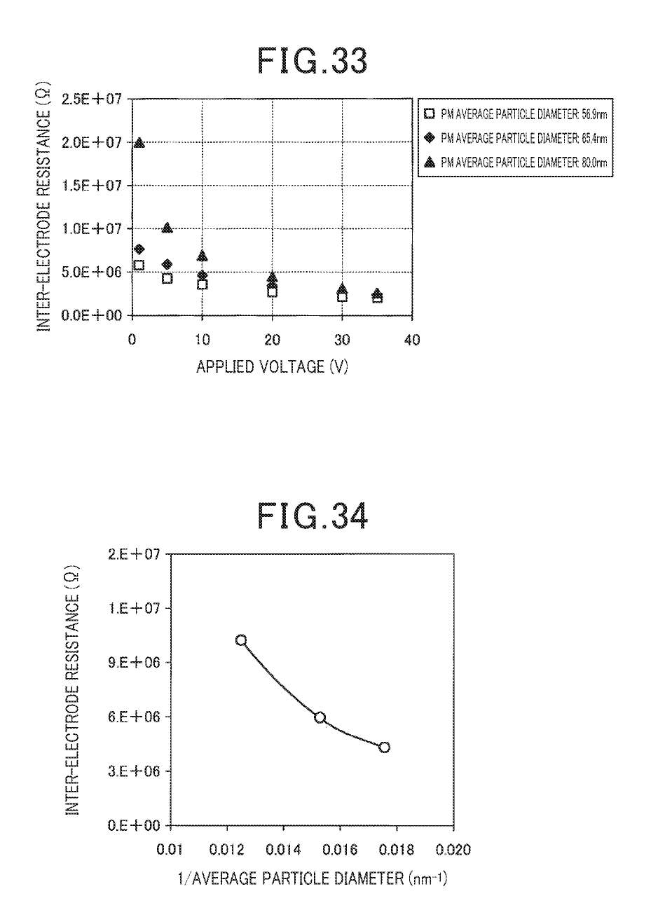

As shown in FIG. 33, in the detecting unit 2 in which the detection conducting portion 23 is used as well, the relationship between the applied voltage and the inter-electrode resistance indicates a tendency for the difference in the inter-electrode resistance R based on the average particle diameter D (such as 56.9 nm, 65.4 nm, and 80.0 nm) to increase as the applied voltage decreases.

Here, the measurement conditions are as follows:

Model gas temperature: 200° C.

Model gas flow rate: 15 m/s

PM concentration: 10 mg/m³

Surface resistivity ρ: 2.4×10⁸ Ω·cm

Average particle diameter D: 56.9 nm, 65.4 nm, 80.0 nm

Electrode interval: 60 μm×5 sets

Particle count N: about 1 to 2×10¹⁴ particles

Therefore, when the applied voltage (that is, the first voltage: such as 35 V) during PM collection is changed to the second voltage (such as 5 V) that is lower, the inter-electrode resistance R increases as the average particle diameter D increases. As shown in FIG. 34, in the relationship between a reciprocal of the average particle diameter D and the inter-electrode resistance R, the inter-electrode resistance R increases as the reciprocal of the average particle diameter D decreases. The average particle diameter D of the particulate matter can be accurately estimated through use of this relationship.

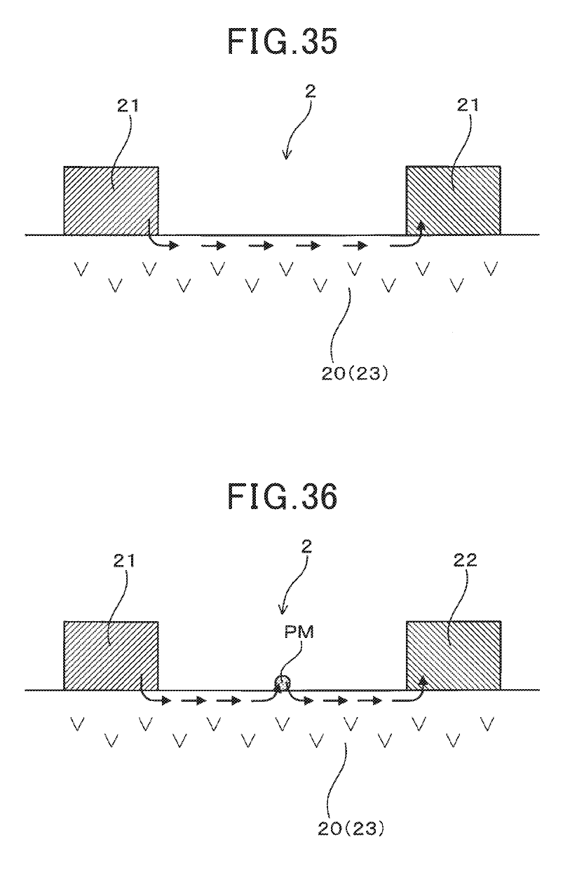

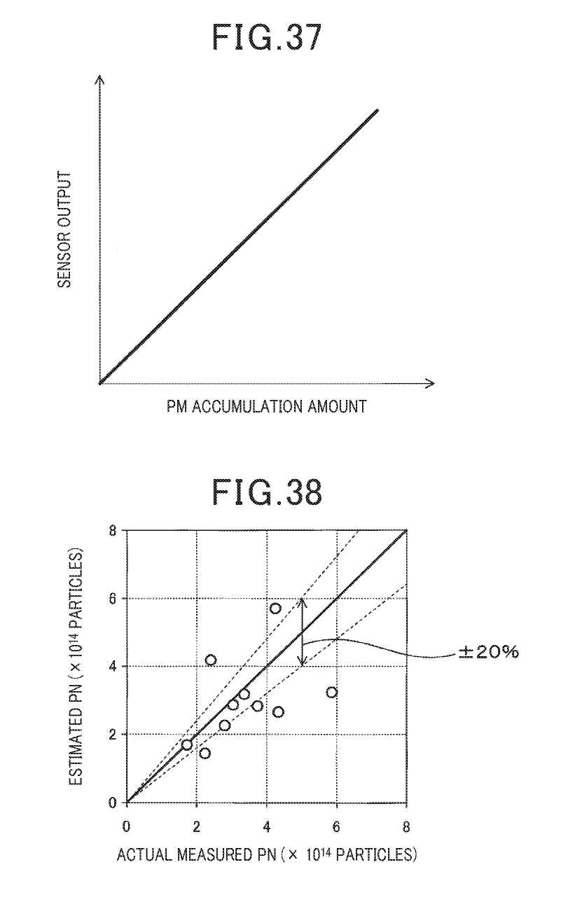

As shown in FIG. 35, in the detecting unit 2 according to the present embodiment, the pair of electrodes 21 and 22 are arranged on the surface of the high-resistance conductive material 20 serving as the detection conducting portion 23. Therefore, even in an initial state in which the particulate matter (that is, PM in FIG. 35) is not accumulated, a minute current (for example, indicated by an arrow in FIG. 35) flows between the electrodes 21 and 22 via the high-resistance conductive material 20. In this state, as shown in FIG. 36, when the particulate matter attaches to the surface of the high-resistance conductive material 20, the inter-electrode resistance R between the pair of electrodes 21 and 22 becomes a combined resistance of the high-resistance conductive material 20 and the particulate matter. Therefore, the inter-electrode resistance R changes by the amount of particulate matter that is attached. Because the high-resistance conductive material 20 has a higher resistivity than the particulate matter, as shown in FIG. 37, the sensor output increases in proportion to the accumulation amount of the particulate matter.

FIG. 38 shows a comparison of the particle count N of the particulate matter that is calculated through the series of steps and a particle count that is actually measured. The estimated number of PM and the actual measured number of PM are confirmed to have a correlation. When the area between the electrodes is formed by an insulating body as according to the above-described embodiments, as shown in FIG. 4, described above, the sensor output cannot be acquired until the particulate matter causes a short circuit between the electrodes. However, according to the present embodiment, the particulate matter can be detected at an amount of accumulation that is more minute than that when the short circuit occurs between the electrodes. Therefore, the particle count N can be calculated even for a minute amount of particulate matter.

### Seventh Embodiment

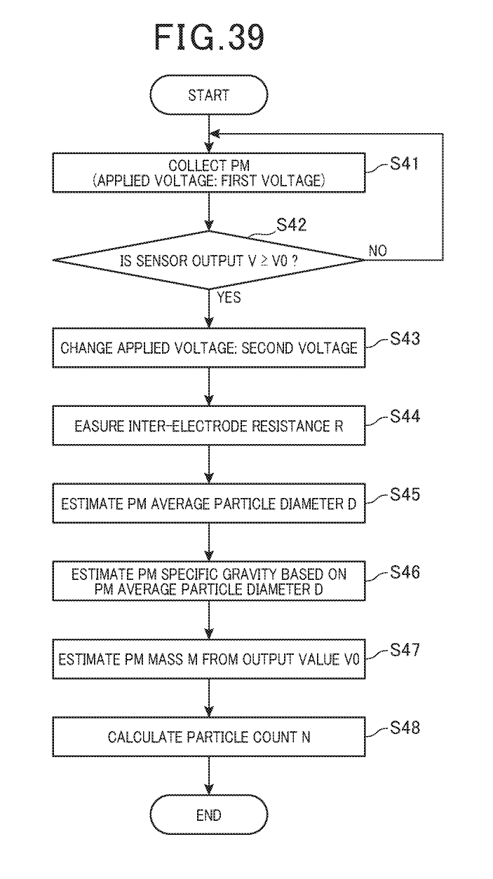

In the detection apparatus according to a seventh embodiment, the basic configurations of the particulate matter detection sensor 1 serving as the sensor unit and the ECU 4 that is the sensor control unit are similar to those according to the above-described first embodiment. According to each of the above-described embodiments, the mass M of the particulate matter is calculated with the specific gravity of the particulate matter as a fixed value. However, instead of the PM specific gravity being a known constant, the PM specific gravity may be estimated based on the estimated average particle diameter D. Details of the particulate matter detection process performed by the ECU 4 in this case will be described with reference to FIG. 39.

As shown in a flowchart in FIG. 39, according to the present embodiment, in the particulate matter detection process performed by the ECU 4 that is the sensor control unit, steps S41 to S45 are the same process as that at steps S1 to S5 according to the first embodiment shown in FIG. 7. That is, the first voltage is applied to the pair of electrodes 21 and 22 of the detecting unit 2 and electrostatic collection is performed. When the sensor output V reaches the output value V0, the applied voltage is changed to the second voltage and the collection state is changed. Subsequently, the ECU 4 proceeds to step S44 and measures the inter-electrode resistance R at the second voltage that serves as the detection voltage. At step S45, the ECU 4 estimates the average particle diameter D of the particulate matter from the inter-electrode resistance R.

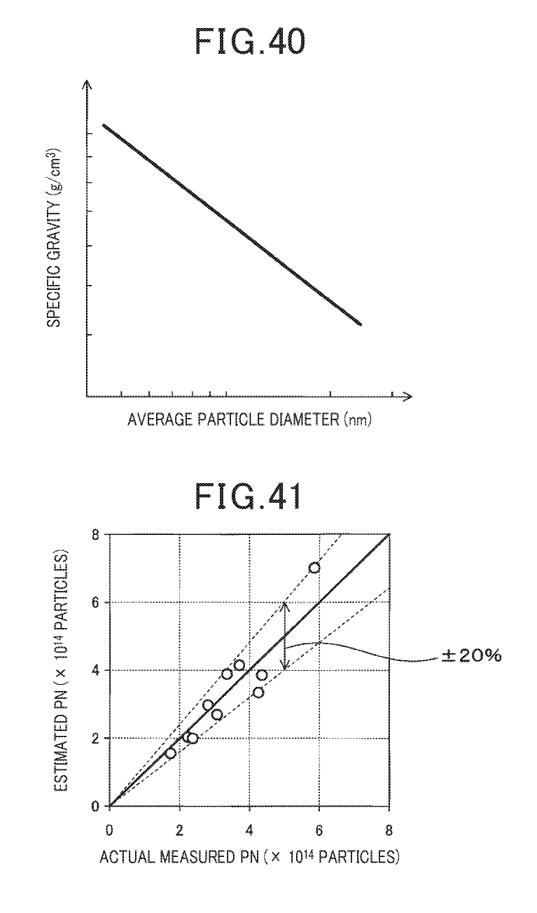

Subsequently, at step S46, the ECU 4 estimates the specific gravity of the collected particulate matter from the estimated average particle diameter D. As shown in FIG. 40, the average particle diameter D (unit: nm) and the specific gravity (unit: g/cm³) have a correlation. It is clear that the PM specific gravity decreases as the average particle diameter D increases. Therefore, the specific gravity at the estimated average particle diameter can be accurately calculated from a relational expression of the average particle diameter D and the PM specific gravity prepared in advance, based on this relationship.

Next, at step S47, the ECU 4 estimates the mass M of the particulate matter based on the output value V0. Furthermore, at step S48, the ECU 4 can calculate the particle count N of the particulate matter using the estimated specific gravity of the particulate matter and the mass M of the particulate matter.

An estimation method for the average particle diameter D that serves as a basis for the calculation of the specific gravity is not limited to the method in which the average particle diameter D is estimated from the inter-electrode resistance R, described herein. A method in which the average particle diameter D is estimated from an increase rate of the sensor output as a result of heating, a method in which the average particle diameter D estimated from high-frequency impedance, or the like can also be used.

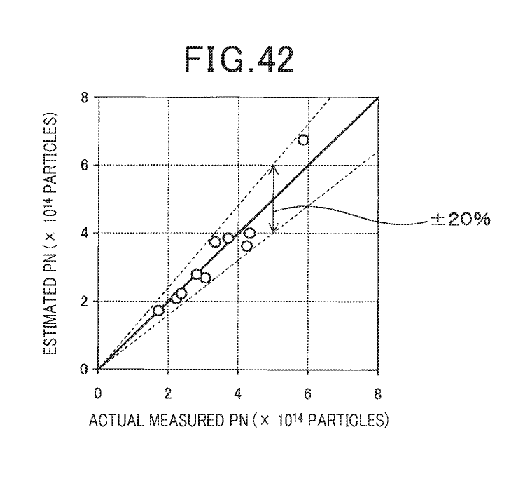

FIG. 41 shows a relationship between the particle count N of the particulate matter that is calculated using the known PM specific gravity, without the estimation of the PM specific gravity at step S46 among the series of steps being performed, and the actual measured particle count. The estimated number of PM is substantially within a range of ±20% of the actual measured number of PM. In contrast, as shown in FIG. 42, when the PM specific gravity estimated at step S46 is used, the difference between the estimated number of PM and the actual measured number of PM decreases. The detection accuracy of the particle count N can be improved.

### Eighth Embodiment

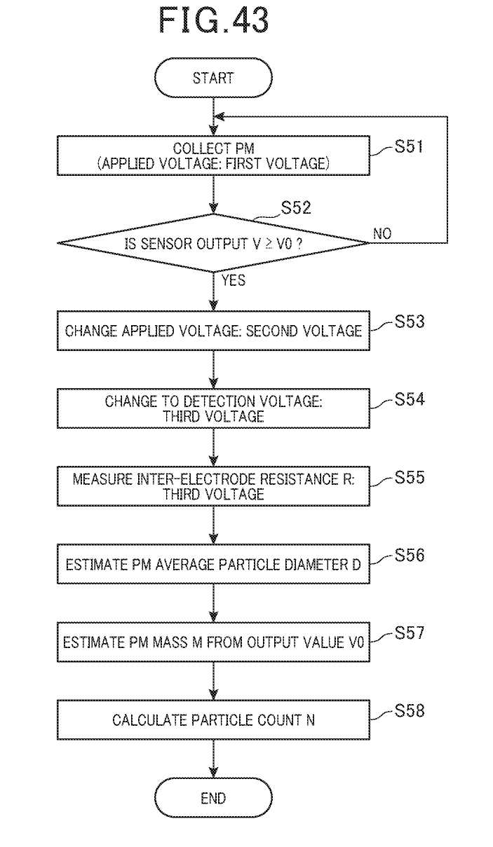

In the particulate matter detection apparatus according to an eighth embodiment, the basic configurations of the particulate matter detection sensor 1 serving as the sensor unit and the ECU 4 that is the sensor control unit are similar to those according to the above-described first embodiment. The sensor element 10 includes the detecting unit 2 in which the detection conductive portion 23 that enables detection of a minute amount of particulate matter is used. According to the above-described sixth embodiment, the inter-electrode resistance R is measured at the second voltage that serves as the detection voltage, after the applied voltage is changed from the first voltage to the second voltage, in a manner similar to that according to the above-described first embodiment. However, according to the present embodiment, the inter-electrode resistance R is measured with the applied voltage being further changed to a detection voltage (such as a third voltage) that differs from the second voltage. Details of the particulate matter detection process performed by the ECU 4 in this case will be described with reference to FIG. 43.

As shown in a flowchart in FIG. 43, according to the present embodiment, the particulate matter detection process performed by the ECU 4 that is the sensor control unit is that in which a portion of the steps according to the first embodiment shown in FIG. 7 has been changed. Specifically, steps S51 to S53 are the same process as that at steps S1 to S3 in FIG. 7. The first voltage is applied to the pair of electrodes 21 and 22 of the detecting unit 2 and electrostatic collection is performed. When the sensor output V reaches the output value V0, the applied voltage is changed to the second voltage and the collection state is changed. Next, the ECU 4 proceeds to step S54 and changes the applied voltage to the pair of electrodes 21 and 22 of the detecting unit 2 from the second voltage to the third voltage.

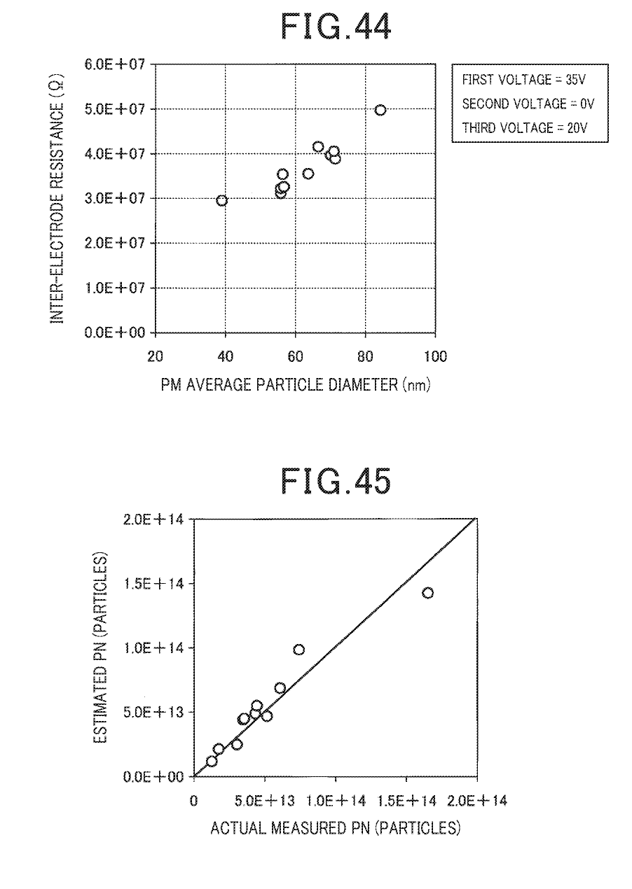

Here, as described above, the collection state of the particulate matter changes and the change in the inter-electrode resistance R increases as the second voltage becomes lower than the first voltage (such as 35 V) during PM collection. However, when the detection voltage decreases, the sensor output also decreases. Therefore, in this case, the applied voltage is preferably changed to the third voltage at which the change in the inter-electrode resistance R is easily identified and the inter-electrode resistance R is measured. As shown in FIG. 44, when the third voltage (such as 20 V) that is higher than the second voltage (such as 0 V) is set, the average particle diameter D and the inter-electrode resistance R indicate a clear proportional relationship. Here, the measurement conditions are as follows:

Model gas temperature: 200° C.

Model gas flow rate: 15 m/s

PM concentration: 1 mg/m³

Surface resistivity ρ: 3.8×10⁸ Ω·cm

Electrode interval: 60 μm×9 sets

Here, for example, the second voltage and the third voltage at steps S53 and S54 are set to 0 V and 20 V based on the relationship shown in FIG. 44. The ECU 4 proceeds to step S55 and measures the inter-electrode resistance R at the third voltage that serves as the detection voltage. Furthermore, the ECU 4 proceeds to step S56 and accurately estimates the average particle diameter D of the particulate matter based on the measured inter-electrode resistance R and the relationship shown in FIG. 44. Subsequently, at step S57, the ECU 4 estimates the mass M of the particulate matter from the output value V0. Then, at step S58, the ECU 4 calculates the particle count N of the particulate matter.

FIG. 45 shows the relationship between the particle count N of the particulate matter calculated through the series of steps and the actual measured particle count. A favorable correlation can be seen between the estimated number of PM and the actual measured number of PM.

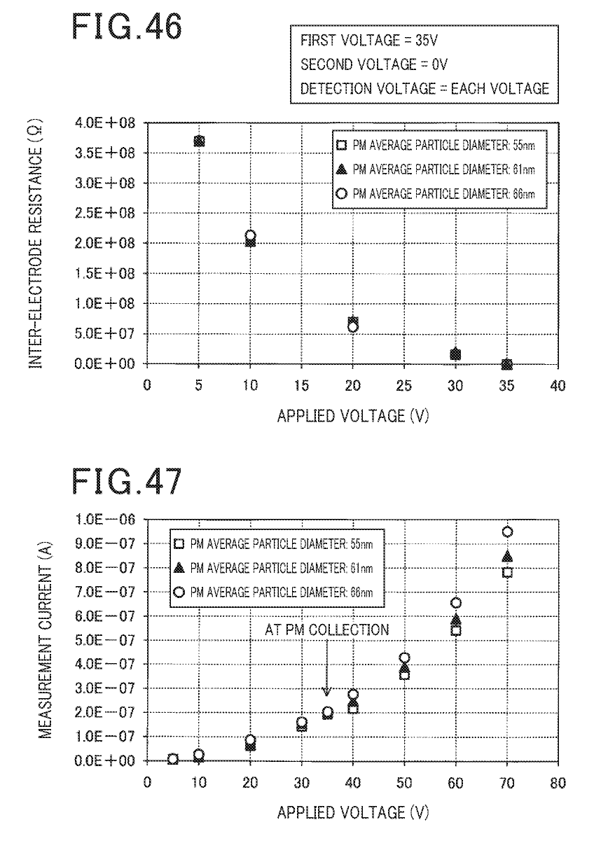

FIG. 46 to FIG. 49 are modifications of the present embodiment. For example, when a very minute amount of particulate matter is detected, the third voltage that is the detection voltage may be set to a voltage that is higher than the first voltage (such as 35 V) during PM collection, based on sensor output characteristics. The measurement conditions in the present example is as follows:

Model gas temperature: 200° C.

Model gas flow rate: 15 m/s

PM concentration: 1 mg/m³

Surface resistivity ρ: 1.0×10¹⁰ Ω·cm

Average particle diameter D: 55 nm, 61 nm, 66 nm

Electrode interval: 80 μm×9 sets

Particle count N: about 1×10¹³ particles

As shown in FIG. 46, even when the particle count N is a minute amount, the tendency for the inter-electrode resistance R to increase as the applied voltage decreases is similar. However, the difference in the inter-electrode resistance R based on the magnitude of average particle diameter D decreases. Therefore, as shown in FIG. 47, when the sensor output (that is, a measurement current) during PM collection decreases and the detection voltage is reduced, the current to be measured further decreases and reaches a measurement limit. The difference in the average particle diameter D can no longer been seen.

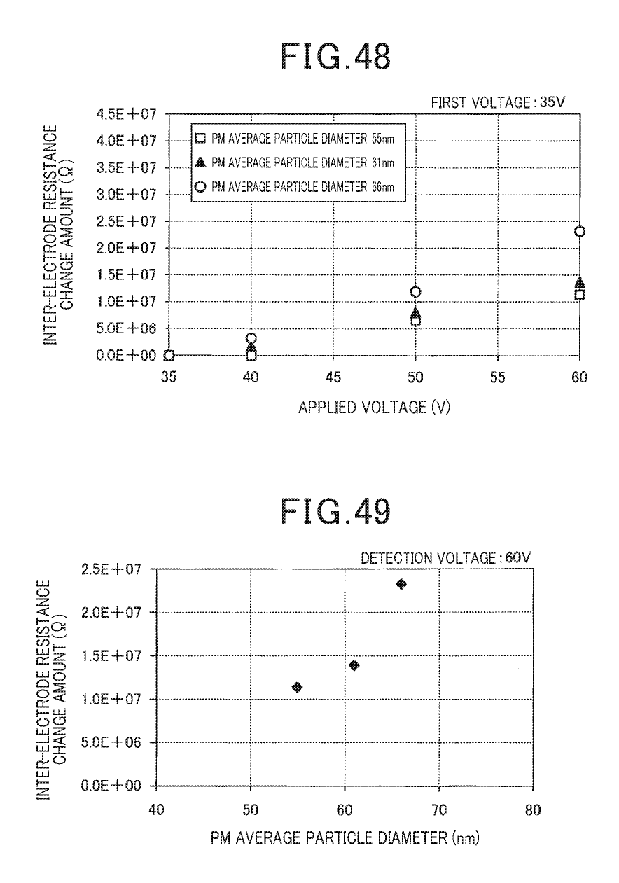

In this case, after the second voltage (such as 0 V) is changed, as shown in FIG. 48, an arbitrary voltage on the side higher than the first voltage (such as 35 V) at which the difference in the measurement current (that is, an inter-electrode resistance change amount) based on the average particle diameter D can be identified can be set as the third voltage. For example, as shown in FIG. 49, when the third voltage is 60 V, the difference in the change amount of the inter-electrode resistance R in relation to the average particle diameter D is sufficiently large. Therefore, the average particle diameter D can be estimated through use of this relationship. The particle count N can be calculated.

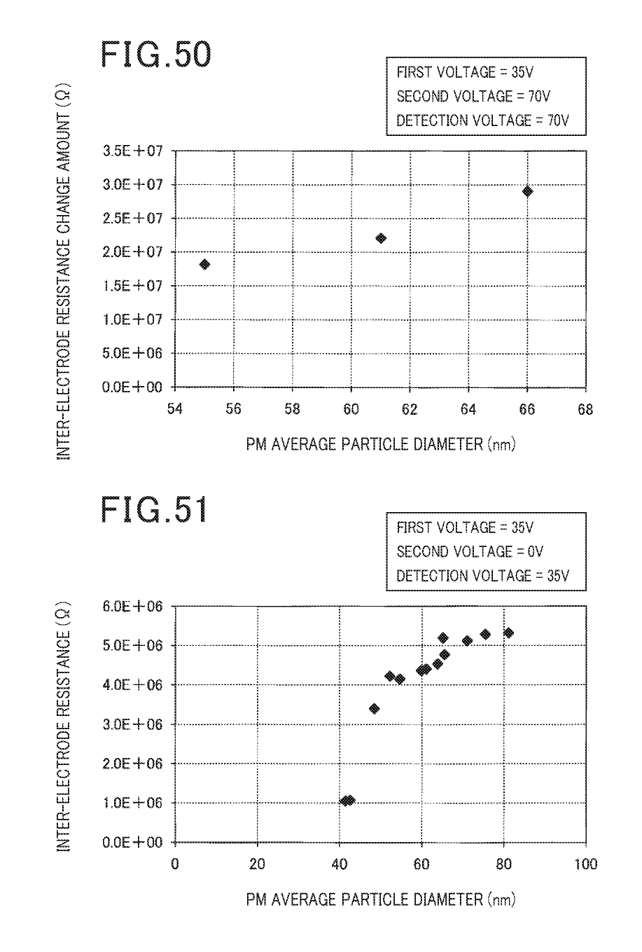

FIG. 50 is a modification of the present embodiment, and shows a relationship between the average particle diameter D and the inter-electrode resistance R when the second voltage (such as 70 V) and the third voltage (such as 70 V) are set to voltages that are higher than the first voltage (such as 35 V).

In a manner similar to the detection voltage, the second voltage can also be set to a voltage that is higher than the first voltage. The change in the collection state can be increased by the difference between the second voltage and the first voltage being increased. In this case, the second voltage and the detection voltage can be set to the same voltage. The inter-electrode resistance R can be measured without the applied voltage being changed.

As shown in FIG. 50, even when the particle count N is a minute amount, the difference in the change amount of the inter-electrode resistance R based on the average particle diameter D can be sufficiently identified as a result of the second voltage and the third voltage being set to be sufficiently higher than the first voltage. Therefore, the average particle diameter D can be estimated through use of this relationship and the particle count N can be calculated.

FIG. 51 is a modification of the present embodiment, and shows a relationship between the average particle diameter D and the inter-electrode resistance R when, after the applied voltage is changed from the first voltage (such as 35 V) to the second voltage (such as 0 V) that is lower than the first voltage, the applied voltage is further changed to a higher detection voltage (that is, the third voltage such as 35 V). The measurement conditions in the present example are as follows. The particulate matter detection sensor 1 uses the sensor element 10 that includes the printed-type detecting unit 2 in which the detection conductive portion 23 is not used.

Model gas temperature: 200° C.

Model gas flow rate: 15 m/s

PM concentration: 10 mg/m3

As shown in FIG. 51, even when the detection voltage is the same voltage as the first voltage, as a result of the applied voltage being temporarily changed to the second voltage and the collection state being changed, the difference in the inter-electrode resistance R based on the average particle diameter D can be sufficiently identified. Therefore, the average particle diameter D can be estimated through use of this relationship and the particle count N can be calculated.

In this manner, the second voltage that changes the collection state of the particulate matter is a higher voltage or a lower voltage than the first voltage, and preferably has a greater potential difference. However, when the second voltage is set to a high voltage, the repulsive force becomes greater than the attractive force that draws the particulate matter. Therefore, the particulate matter may become detached or discharge may occur. The second voltage is preferably set to a voltage that is high to an extent that such issues do not occur. In addition, when the second voltage is set to a low voltage, the intensity of the electrostatic field between the electrodes weakens, and as a result, the contact state easily changes. The intensity of the electrostatic field at an applied voltage of 0 V is also 0. Therefore, the effect of changing the contact state becomes the greatest.

The detection voltage at which the inter-electrode resistance R is measured is merely required to be a voltage at which the difference in the inter-electrode resistance R based on particle diameter can be read. The difference can be more easily read when the detection voltage is a high voltage. In particular, in the case of estimation of the average particle diameter D and calculation of the particle count N of a minute amount of particulate matter, the difference in the inter-electrode resistance based on particle diameter is not clear at a low voltage. Therefore, a high voltage is preferable. However, the voltage is required to be kept at a voltage at which detachment of the particulate matter and discharge do not occur. As long as the difference in the inter-electrode resistance R based on particle diameter can be read, the second voltage and the detection voltage may be the same. In addition, the change in the inter-electrode resistance R includes irreversible change. Therefore, when the second voltage that changes the collection state of particulate matter is narrowed, the first voltage that is the collection voltage and the detection voltage at which the inter-electrode resistance is measured may be the same.

As described according to the embodiments above, as a result of the sensor control unit that applies a voltage to the detecting unit 2 of the particulate matter detection sensor 1 and collects particulate matter, and also changes the applied voltage, measures the inter-electrode resistance R, and calculates the particle count of the particulate matter being provided, the particle count of the particulate matter can be accurately detected. In addition, the particulate matter detection apparatus such as this can be used in an exhaust purification apparatus of an internal combustion engine or the like, and can perform a failure diagnosis of the DPF 5 that is arranged upstream.

According to the embodiments above, the average particle diameter of the particulate matter is estimated from the resistance value that is determined by the voltage being changed. However, the average particle diameter D of the particulate matter may be estimated through use of a resistance value that is determined by a current being changed. That is, a first current may be applied to the detecting unit 2 of the particulate matter detection sensor 1 and the particulate matter may be collected. In addition, in a state in which the sensor output has reached a threshold, the applied current may be changed to a second current that differs from the first current, and the inter-electrode resistance R in the detecting unit 2 may be detected.

Furthermore, according to the above-described embodiments, the threshold is set to the predetermined output value V0 that serves as a detection reference in the collection control unit 41. However, the threshold is not limited thereto. The threshold can be arbitrarily set based on the sensor output V at which detection of the particulate matter becomes possible.

Alternatively, the threshold is not limited to the sensor output V and may be a value that serves as a reference that indicates that the state is such that the detection of the particulate matter can be performed. For example, the threshold may be set based on an elapsed time (such as the detection time tin FIG. 4) from when the electrostatic collection is started by the first voltage being applied in the collection control unit 41 until the detection of the particulate matter can be performed.

Here, the sensor output may be an output voltage or an output current.

The particulate matter detection apparatus of the present disclosure that includes the particulate matter detection sensor 1 and the ECU 4 is not limited to the above-described embodiments. Various modifications are possible without departing from the spirit of the present disclosure. For example, according to the above-described embodiment, the protective cover 12 that covers the sensor element 10 of the particulate matter detection sensor 1 has a single-layer cylindrical structure. However, the protective cover 12 may have a double-layer cylindrical structure that includes an inner cylinder and an outer cylinder. The arrangements and quantities of the gas-to-be-measured flow holes 13 and 14 that are provided in the protective cover 12 can also be arbitrarily set. In addition, the shapes, materials, and the like of each section of the sensor element 10 and the protective cover 12 that configure the particulate matter detection sensor 1 can be changed as appropriate.

Furthermore, according to the above-described first embodiment, the internal combustion engine E is a diesel engine and the DPF 5 that serves as the particulate matter collecting portion is provided thereto. However, the internal combustion engine E may be a gasoline engine and a gasoline particulate filter may be arranged. In addition, the gas to be measured is not limited to the combustion exhaust gas of the internal combustion engine E, and any type of gas is applicable as long as the gas to be measured contains particulate matter.

The present disclosure is not limited to the above-described embodiments and can be applied to various embodiments without departing from the spirit of the invention.

What is claimed is:

1. A particulate matter detection apparatus that detects particulate matter contained in a gas to be measured, the particulate matter detection apparatus comprising:
a sensor unit that includes a detecting unit in which a pair of electrodes that are separated from each other are arranged on a surface of a substrate that is exposed to the gas to be measured, and outputs a signal based on an amount of particulate matter that is electrostatically collected in the detecting unit; and
a sensor control unit that detects a particle count of the particulate matter that is electrostatically collected in the detecting unit, based on a sensor output that is transmitted from the sensor unit, wherein
the sensor control unit includes
a collection control unit that applies a first voltage between the pair of electrodes of the detecting unit and electrostatically collects the particulate matter in the detecting unit, and
a particle count calculating unit that, after changing the applied voltage between the pair of electrodes to a second voltage that differs from the first voltage in a state in which the sensor output at the first voltage has reached a threshold, detects a resistance value between the pair of electrodes, and calculates the particle count using an average particle diameter of the particulate matter that is estimated from the resistance value and a mass of the particulate matter that is estimated from the sensor output.

2. The particulate matter detection apparatus according to claim 1, wherein:
the particle count calculating unit includes
a voltage control unit that, after changing the applied voltage between the pair of electrodes to the second voltage for changing a collection state of the particulate matter when the sensor output at the first voltage for electrostatic collection reaches the threshold, controls the applied voltage to a detection voltage that is a voltage that is the same as or differs from the second voltage and is for inter-electrode resistance detection; and
an inter-electrode resistance detecting unit that detects the resistance value between the pair of electrodes at the detection voltage.

3. A particulate matter detection apparatus that detects particulate matter contained in a gas to be measured, the particulate matter detection apparatus comprising:
a sensor unit that includes a detecting unit in which a pair of electrodes that are separated from each other are arranged on a surface of a substrate that is exposed to the gas to be measured, and outputs a signal based on an amount of particulate matter that is electrostatically collected in the detecting unit; and
a sensor control unit that detects a particle count of the particulate matter that is electrostatically collected in the detecting unit, based on a sensor output that is transmitted from the sensor unit, wherein
the sensor control unit includes
a collection control unit that applies a first voltage between the pair of electrodes of the detecting unit and electrostatically collects the particulate matter in the detecting unit, and
a particle count calculating unit that, after changing the applied voltage between the pair of electrodes to a second voltage that differs from the first voltage in a state in which the sensor output at the first voltage has reached a threshold, detects resistance values between the pair of electrodes at a plurality of voltages of which the magnitude differs, and calculates the particle count using an average particle diameter of the particulate matter that is estimated from the resistance values and a mass of the particulate matter that is estimated from the sensor output.

4. The particulate matter detection apparatus according to claim 3, wherein:
the particle count calculating unit includes
a voltage control unit that, after changing the applied voltage between the pair of electrodes to the second voltage for changing a collection state of the particulate matter when the sensor output at the first voltage for electrostatic collection reaches the threshold, successively controls the applied voltage to the plurality of voltages that serve as a detection voltage for inter-electrode resistance detection; and
an inter-electrode resistance detecting unit that detects the respective resistance values between the pair of electrodes at the plurality of voltages.

5. The particulate matter detection apparatus according to claim 3, wherein:
the particle count calculating unit performs weighting on the respective resistance values detected at the plurality of voltages and estimates the average particle diameter.

6. A particulate matter detection apparatus that detects particulate matter contained in a gas to be measured, the particulate matter detection apparatus comprising:
a sensor unit that includes a detecting unit in which a pair of electrodes that are separated from each other are arranged on a surface of a substrate that is exposed to the gas to be measured, and outputs a signal based on an amount of particulate matter that is electrostatically collected in the detecting unit; and
a sensor control unit that detects a particle count of the particulate matter that is electrostatically collected in the detecting unit, based on a sensor output that is transmitted from the sensor unit, wherein
the sensor control unit includes
a collection control unit that applies a first voltage between the pair of electrodes of the detecting unit and electrostatically collects the particulate matter in the detecting unit, and
a particle count calculating unit that, after changing the applied voltage between the pair of electrodes to a second voltage that differs from the first voltage in a state in which the sensor output at the first voltage has reached a threshold, detects resistance values between the pair of electrodes at a plurality of voltages of which the magnitude differs, and calculates the particle count using an average particle diameter of the particulate matter that is estimated from an inclination in a relationship between the plurality of voltages and the resistance values, and a mass of the particulate matter that is estimated from the sensor output.

7. The particulate matter detection apparatus according to claim 6, wherein:
the particle count calculating unit includes:
a voltage control unit that, after changing the applied voltage between the pair of electrodes to the second voltage for changing a collection state of the particulate matter when the sensor output at the first voltage for electrostatic collection reaches the threshold, successively controls the applied voltage to the plurality of voltages that serve as a detection voltage for inter-electrode resistance detection; and
an inter-electrode resistance detecting unit that detects the respective resistance values between the pair of electrodes at the plurality of voltages, and an inclination calculating unit that calculates the inclination in the relationship between the plurality of voltages and the resistance values.

8. The particulate matter detection apparatus according to claim 3, wherein:
the plurality of voltages include a voltage of which the magnitude is the same as that of the second voltage.

9. A particulate matter detection apparatus that detects particulate matter contained in a gas to be measured, the particulate matter detection apparatus comprising:
a sensor unit that includes a detecting unit in which a pair of electrodes that are separated from each other are arranged on a surface of a substrate that is exposed to the gas to be measured, and outputs a signal based on an amount of particulate matter that is electrostatically collected in the detecting unit; and
a sensor control unit that detects a particle count of the particulate matter that is electrostatically collected in the detecting unit, based on a sensor output that is transmitted from the sensor unit, wherein
the sensor control unit includes
a collection control unit that applies a first current between the pair of electrodes of the detecting unit and electrostatically collects the particulate matter in the detecting unit, and
a particle count calculating unit that, after changing the applied current between the pair of electrodes to a second current that differs from the first current in a state in which the sensor output at the first current has reached a threshold, detects a resistance value between the pair of electrodes, and calculates the particle count using an average particle diameter of the particulate matter that is estimated from the resistance value and a mass of the particulate matter that is estimated from the sensor output.

10. The particulate matter detection apparatus according to claim 1, wherein:
the threshold is set based on the sensor output at which detection of the particulate matter can be performed or an elapsed time from start of electrostatic collection until detection of the particulate matter can be performed, in the collection control unit.

11. The particulate matter detection apparatus according to claim 1, wherein:
the threshold is an output value that serves as a detection reference for the particulate matter in the collection control unit; and
the particle count calculating unit calculates the mass of the particulate matter using the output value that serves as the detection reference.

12. The particulate matter detection apparatus according to claim 1, wherein:
the sensor unit includes a heater unit that includes heater electrode that heats the detecting unit; and
the sensor control unit includes a heating control unit that supplies electric power to the heater unit, and heats and holds the detecting unit at a temperature at which soluble organic fraction in the particulate matter can be volatilized and soot is not burned.

13. The particulate matter detection apparatus according to claim 12, wherein:
the temperature is a temperature that is 200° C. or higher and 400° C. or lower.

14. The particulate matter detection apparatus according to claim 12, wherein:
the threshold is an output value that serves as a detection reference for the particulate matter in the collection control unit; and
the particle count calculating unit calculates the mass of the particulate matter using the output value that serves as the detection reference or a first output value that is the sensor output during heating and holding by the heating control unit.

15. The particulate matter detection apparatus according to claim 1, wherein:
the particle count calculating unit calculates the particle count from the mass of the particulate matter, the average particle diameter of the particulate matter, and a specific gravity of the particulate matter.

16. The particulate matter detection apparatus according to claim 15, wherein:
the specific gravity of the particulate matter is a fixed value or a value that is estimated based on the average particle diameter of the particulate matter that is estimated by the particle count calculating unit.

17. The particulate matter detection apparatus according to claim 1, wherein:
the substrate includes an insulating material.

18. The particulate matter detection apparatus according to claim 1, wherein:
the detecting unit has a detection conductive portion arranged on a surface of the substrate and has the pair of electrodes that are separated from each other on a surface of the detection conductive portion on a side opposite the substrate.

19. The particulate matter detection apparatus according to claim 18, wherein:
the detection conductive portion includes a conductive material of which resistivity is higher than that of the particulate matter.

20. The particulate matter detection apparatus according to claim 18, wherein:
the detection conductive portion includes conductive material of which a surface resistivity ρ is 1.0×10⁷ to 1.0×10¹⁰ Ω·cm at a temperature range from 100 to 500° C.

21. The particulate matter detection apparatus according to claim 20, wherein:
the conductive material is a ceramic that has a perovskite structure of which a molecular formula is expressed by ABO₃, where an A site in the molecular formula is at least one type selected from La, Sr, Ca, and Mg, and a B site is at least one type selected from Ti, Al, Zr, and Y.

22. The particulate matter detection apparatus according to claim 21, wherein:
in the A site, a main component is Sr and a sub-component is La, and the B site is Ti.
